(19) United States
(12) Patent Application Publication
(10) Pub. No.: US 2005/0030508 A1
(43) Pub. Date: Feb. 10, 2005

(54) Scanning exposure method, scanning exposure apparatus and its making method, and device and its manufacturing method

(75) Inventors: Noriaki Tokuda, Kawasaki-shi (JP); Kenichi Shiraishi, Kumagaya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: NIKON CORPORATION, Chiyoda-ku (JP)

(21) Appl. No.: 10/939,334

(22) Filed: Sep. 14, 2004

Related U.S. Application Data
(63) Continuation of application No. 10/376,616, filed on Mar. 3, 2003.
Application No. 10/376,616 is a division of application No. 09/659,081, filed on Sep. 11, 2000, now abandoned.
Application No. 09/659,081 is a continuation of application No. PCT/JP99/01118, filed on Mar. 9, 1999.

(30) Foreign Application Priority Data
Mar. 9, 1998 (JP) 10-74913
Jul. 3, 1998 (JP) 10-204445

(51) Int. Cl. G03B 27/72

(52) U.S. Cl. 355/69; 355/53

(57) ABSTRACT

A control system adjusts the exposure of a wafer according to the transfer error of a pattern line width caused when a certain integrated exposure over the whole shot areas is made a desired value when a pattern is transferred to a wafer and according to information corresponding to the desired value of the integrated exposure stored in a storage device, then performing scanning exposure. As a result, influences such as of fog exposure due to flare are mitigated, and the uniformity of line width distribution with high precision is ensure over the shot regions on the wafer, achieving pattern transfer to each shot region.

### CROSS-REFERENCE TO RELATED APPLICATIONS

This is a continuation of International Application PCT/JP99/01118, with an international filing date of Mar. 9, 1999, the entire content of which is hereby incorporated by reference.

### BACKGROUND OF THE INVENTION

1. Field of the Invention

The present invention relates to a scanning exposure method, a scanning exposure apparatus and its making method, and a device and its manufacturing method. More particularly, the present invention relates to a scanning exposure method and apparatus used in a lithography process of manufacturing a microdevice such as a semiconductor device, a liquid crystal display device, an imaging sensing device (CCD or the like) or a thin-film magnetic head, a method of making the scanning exposure apparatus, a microdevice manufactured by using the scanning exposure apparatus, and a method of manufacturing the device.

2. Description of the Related Art

Conventionally, in manufacturing various semiconductor devices including integrated circuits such as microprocessors and DRAMs and liquid crystal display devices, projection exposure apparatus have been widely used. These projection exposure apparatus are designed to transfer a circuit pattern formed on a mask or reticle (to be generically referred to as a “reticle” hereinafter, as needed) onto each shot area on a sensitive substrate such as a wafer or glass plate (to be generically referred to as a “wafer” hereinafter, as needed) coated with a resist (photosensitive agent) through a projection optical system. Recently, with the increase in degree of integration of devices and the decrease in device rule (minimum line width), scanning exposure apparatus based on the step-and-scan method (so-called scanning steppers) capable of high-precision exposure on a large area compared with so-called steppers based on the step-and-repeat method are becoming mainstream.

FIG. 13A schematically shows how a pattern on a reticle R is transferred/exposed onto a shot area SA on a wafer W as a substrate by using such a scanning exposure apparatus. As shown in FIG. 13A, in this scanning exposure apparatus, a slit-like illumination area IRA on the reticle R is illuminated with exposure light EL from an illumination optical system (not shown in FIG.), and the circuit pattern in the illumination area IRA is projected onto the wafer W coated with the resist through a projection optical system PL. As a consequence, a reduced image (partial inverted image) of the pattern in the illumination area IRA is transferred onto an exposure area IA conjugated to the illumination area IRA on the wafer W. In this case, the reticle R and wafer W have an inverted image relationship, so a reticle stage RST holding the reticle R and a wafer stage WST holding the wafer W are. synchronously moved (scanned) in opposite directions along the scanning direction (the lateral direction on the drawing surface of FIG. 13A) at a velocity ratio corresponding to the projection magnification of the projection optical system PL. Thus, the entire surface of the pattern region PA on the reticle R is accurately transferred onto the shot area SA on the wafer W.

In a general scanning exposure apparatus, the positions of the reticle R and wafer W within a plane perpendicular to the optical axis direction of the projection optical system PL are measured with high precision by a laser interferometer system or the like. And based on the measurement results, the pattern formed on the reticle R is sequentially transferred onto a plurality of shot areas SA on the wafer W. This is performed by repeating synchronous movement to transfer the pattern formed on the reticle R onto the wafer W, and stepping the wafer W to a scanning start position for exposure on the next shot area of SA. Also, the position of the exposure area on the wafer W in the optical axis direction of the projection optical system, as well as the tilt of the exposure area in respect to a plane perpendicular to the optical axis direction of the projection optical system, are precisely measured by a focus sensor or the like. Based on the measurement results, focus control of the exposure area on the wafer W is performed with respect to an image plane of the projection optical system. With the synchronous movement control and focus control described above as a premise, by keeping a steady amount of illumination light irradiated on the reticle R during scanning exposure of the shot areas SA on the wafer W, the line width distribution uniformity of a pattern being transferred onto the respective shot areas SA is secured. That is, a pattern formed on the reticle R is transferred with the same line width, with a uniform line width.

In the conventional scanning exposure apparatus, the line width distribution uniformity of a pattern in shot areas has been secured as described above. With the conventional apparatus, however, exposure light is scattered in the illumination optical system, projection optical system, or the like and flare is generated that affect the line width uniformity of the pattern, which is greatly dependent on whether there is an adjacent shot.

Flare occurs by internal scattering of a glass material or the like used for an optical system such as the illumination optical system or projection optical system in the scanning exposure apparatus. It also occurs based on the unevenness of a surface finish or coating, or scattering on the surface of a member holding an optical member, and the like. Such flare is basically an unnecessary component for image forming, but an optical system has the characteristics to retain such an unnecessary component. Flare is a light component which overlays on a beam of exposure light that contributes to image forming. This component becomes a factor that degrades the contrast of a pattern image and causes exposure with fog due to flare (to be referred to as “fog exposure” hereinafter). If a positive photosensitive material is used, fog exposure can be observed as a phenomenon in which the line width of a pattern image decreases.

FIG. 13B is a plan view visually showing how flare leaks out from the shot area SA when projection exposure is performed of the entire pattern region PA on the reticle R onto the shot area SA on the wafer W. In this case, as shown in FIG. 13C, the light intensity of the flare component leaking out from the shot area is about 1% of the light intensity of an illumination beam irradiating the shot area in FIG. 13C. The length of a flare component leaking out from a shot area (the width of a leaking portion) is also said to be about several mm in an optical system for a current semiconductor exposure apparatus which has a field size of about 20 to 30 mm. In this case, naturally, fog exposure (overlay) due to flare occurs inside a shot area on the wafer W, causing the following phenomenon.

In other words, the distance (the width of street lines) between shot areas on a wafer exposed by a stepper or scanning stepper generally used for exposure on a semiconductor chip is about several ten to several hundred μm, thus, the length of a flare component leaking out from a shot is much larger than the distance between shot areas on the wafer. Shot areas located near an adjacent shot area of each shot area are affected by fog exposure due to flare produced when exposing the adjacent shot area. The results of actual exposure show that the line width uniformity of a pattern in respective shot areas located in an inner portion of a wafer is almost uniform compared with the circumferential area, therefore, it can be assumed that the fog exposure due to flare, as described above, unified the exposure amount.

However, in the case of an edge shot that is located on a circumferential portion of a wafer (in this specification, an “edge shot” is a shot area located on the circumferential portion of the wafer W, and lacks an adjacent shot on at least one side in the scanning direction or in the non-scanning direction), the circumferential portion has an edge where it lacks an adjacent shot area. So it is not affected by the fog exposure due to flare which occurs upon exposure on an adjacent shot area. Consequently, the edge shots differ from that of the inner shot areas where line width is thinner by fog exposure, and a change in line width occur within the edge shots.

As a method of suppressing variations in line width in edge shots due to the above change in line width, a method of exposing shot areas outside the edge shots (referred to as dummy shots) aimed for exposure amount correction and not for obtaining a chip, is available. FIG. 14 shows an example of the arrangement of shot areas on the wafer W including the dummy shots. In the case shown in FIG. 14, the essential shots (white shot areas) are 52, and 24 shots are dummy shots (colored areas) further required.

Exposure on dummy shots, however, is exposure on shots which do not contribute to the production of a chip, therefore, as in the case above when many as half of the essential shots are exposed as dummy shots, this greatly decreases the productivity (throughput).

Furthermore, with the scanning exposure apparatus, the preciseness of synchronous movement control and focus control described earlier have their limits, and hence the line width uniformity of a transferred pattern have been ensured within these limits. That is, various stage precision errors have remained unsolved. For example, a synchronous movement error between a reticle and a wafer, a focus control (focusing control and leveling control) error, a skew error (orthogonal degree error), and scanning magnification error were factors of line width uniformity being uneven in the scanning direction on scanning exposure on shot areas.

Additionally, line width uniformity being uneven is also caused by a reticle drawing error, although this does not originate from the scanning exposure apparatus itself. Also, when a wafer is coated with the resist by spin coating, the resist concentrically spreads from the center of the wafer, causing the resist thickness to vary. As a consequence, the line width of a pattern becomes uneven.

Recently, with the requirements of operation speed increasing in logic devices including microprocessors in particular, there is an rising demand for line width uniformity of a circuit pattern, which is an indispensable condition for a stable, high-speed operation. The precision required tends to exceed the precision limits of line width uniformity, which is determined by the precision limits of the synchronous movement control, focus control precision, and the like described above.

### SUMMARY OF THE INVENTION

The present invention has been made in consideration of the situation described above, and has as its first object to provide a scanning exposure method and apparatus, which can ensure line width uniformity in each shot area on a substrate with high precision.

It is the second object of the present invention to provide a device on which a fine pattern is formed with high precision.

According to the first aspect of the present invention, there is provided a first scanning exposure method of sequentially transferring a pattern formed on a mask onto a plurality of shot areas on a substrate through a projection optical system, in which the mask and the substrate are moved synchronously while illuminating the mask with an exposure light, the method comprising: transferring the pattern onto a specific shot area which is located at an edge of the substrate; and performing exposure amount adjustment, in a manner that an exposure amount at an edge portion of the specific shot area is different from that of a remaining portion in the specific shot area, when the specific shot area is to be exposed, the edge portion being located on a side where there is no adjacent shot area.

According to the first exposure method of the present invention, when the pattern formed on the mask is to be sequentially transferred onto the plurality of shot areas on the substrate through the projection optical system while the mask and substrate are synchronously moving, exposure amount adjustment is performed at the edge portion of a specific shot area located at the edge portion on the substrate. This edge portion is located on the side where there is no adjacent shot area, and exposed in a manner different from that of the remaining portion, thus pattern transfer is performed. In this case, for example, at the edge portion of the specific shot area, which is located on the side with no adjacent shot area, the exposure amount is different from other remaining areas having adjacent shot areas. This is because the fog exposure component due to scattered light is smaller in light intensity than that of the other areas because of lacking adjacent shot areas. So, the specific shot area is to be exposed so that exposure amount adjustment at the edge portion differs from that of the remaining portion. This makes it possible to improve the uniformity of exposure amount in the specific shot area. With this operation, the number of dummy shots can be reduced compared to the conventional method in which dummy exposure is performed on all the specific shot areas on the edge portion sides. Therefore, line width uniformity can be identically secured with high precision in the respective shot areas on the substrate, and the throughput can be increased.

In this case, various forms of exposure amount adjustment in the above specific shot area can be considered. For example, the exposure amount adjustment can be performed so that an exposure amount at the edge portion of the shot specific area is larger than that of the remaining portion. In this case, the influence of fog exposure due to scattered light at the edge portion being reduced because of the lack of an adjacent shot can be slightly reduced to improve the uniformity of exposure amount in the specific shot area.

In addition, the exposure amount adjustment can be performed by gradually increasing an exposure amount at the edge portion of the specific shot area step by step as the distance becomes far from a center of the specific shot area. In this case, the exposure amount uniformity near the edge portion can be improved more than the case above.

Furthermore, the exposure amount adjustment can be performed by gradually increasing an exposure amount at the edge portion of the specific shot area continuously as the distance becomes far from the center of the specific shot area. In this case, the exposure amount uniformity near the edge portion can be improved more than the two cases above.

Obviously, the state of scattered light caused by the projection optical system depends on the transmittance of a mask, the numerical aperture (N.A.) of the projection optical system, and illumination conditions such as the type of pattern on the mask. In the first scanning exposure method according to the present invention, therefore, it is preferable that the exposure amount adjustment is performed by changing an exposure amount at the edge portion of the specific shot area in accordance with a predetermined function corresponding to at least one of a transmittance of the mask and an illumination condition. In such a case, the exposure amount at the edge portion of the specific shot area where there is no adjacent shot in the scanning direction is appropriately adjusted. The adjustment is performed in accordance with the predetermined function using the transmittance of the mask, illumination conditions, or both of the transmittance of the mask and illumination conditions. This makes it possible to improve the line width uniformity in the specific shot area without being influenced by a change in mask transmittance, i.e., a change of mask, and changes in illumination conditions.

Although the predetermined function may be obtained by performing a complicated computation including factors that define the transmittance of a mask and illumination condition as parameters, the predetermined function can be obtained in advance by experiment. In such a case, when the predetermined function is accurately obtained in advance by, for example, actually measuring the light intensity distribution of illumination light in each shot area on a substrate, performing complicated computation on exposure becomes unnecessary. And in accordance with the previously obtained predetermined function, by changing the exposure amount at the edge portion of the specific shot area which lack adjacent shots, high-precision line width uniformity can be achieved in each specific shot area.

In the first scanning exposure method according to the present invention, the edge portion of the specific shot area can be at least one of an edge portion in a first direction which is a moving direction in which the substrate is moved for exposure of the specific shot area, and an edge portion in a second direction perpendicular to the first direction. In such a case, if the edge portion of the specific shot area having no adjacent shots is in the first direction (so-called scanning direction), dummy shot can be omitted in a region adjacent to the shot area located at the edge portion in the first direction on the substrate. In addition, if the edge portion of the specific shot area having no adjacent shots is in these second direction (so-called non-scanning direction), a dummy shot in an area adjacent to the shot area located at the edge portion in the second direction on the substrate can be omitted. Furthermore, if the edge portion of the specific shot area, having no adjacent shot areas is an edge portion in the first or second direction, each of all edge shots located at edge portions on the substrate can be the specific shot area, and all dummy shots can be omitted. This can greatly increase the throughput.

In this case, the edge portion of the specific shot area is an edge portion in the first direction, and the exposure amount adjustment can be performed during scanning exposure of the specific shot area. Various exposure amount adjustment methods are conceivable. For example, when the exposure light is a pulse light emitted from a pulse illumination light source, the exposure amount adjustment can be performed by adjusting at least one of an oscillation frequency of the pulse illumination light source and energy of pulse illumination light. In addition, when the exposure light is a lamp light emitted from a lamp light source, the exposure amount adjustment can be performed by adjusting at least one of a lamp power and a transmittance control element arranged on an optical path of the exposure light.

Regardless of the light source of exposure light being a pulse illumination light source or a continuous light source, the exposure amount adjustment can be performed by changing at least one of a moving velocity of the substrate and a width of an exposure area on the substrate in the first direction (scanning direction).

In the first scanning exposure method according to the present invention, the edge portion of the specific shot area can be an edge portion in the second direction, i.e., the non-scanning direction. In such a case, various exposure amount adjustment methods can be considered. For example, the exposure amount adjustment can be performed by adjusting an illuminance distribution of exposure light irradiated onto the substrate in a direction corresponding to the second direction.

According to the second aspect of the present invention, there is provided a second scanning exposure method of sequentially transferring a pattern formed on a mask onto a plurality of shot areas on a substrate through a projection optical system, in which the mask and the substrate are moved synchronously while illuminating the mask with an exposure light, the method comprising: judging whether there is an adjacent shot area in a predetermined direction before transferring the pattern onto each shot area on the substrate; calculating a second function for exposure amount correction performed for a specific shot area where there is no adjacent shot area in the predetermined direction, by using a first function corresponding to at least one of a transmittance of the mask and an illumination condition; and transferring the pattern onto the specific shot area while controlling an exposure amount based on a calculation result obtained in the calculating.

According to this method, before a mask pattern is transferred onto a shot area on the substrate, it is determined in the judging step whether there is an adjacent shot area in a predetermined direction. If the judgement in the judging step is negative, in the calculating step, a second function for exposure amount correction in the shot area is calculated by using a first function corresponding to at least one of the transmittance of the mask and the illumination condition. The exposure amount is controlled based on the calculation result obtained in the calculation step, thereby transferring the mask pattern onto the shot area. Therefore, the exposure amount uniformity in the shot area can be improved without being affected by the transmittance of the mask and the illumination condition. As a consequence, dummy shots are no longer required outside the side of the shot area which has no adjacent shot in the predetermined direction. In this case, the exposure amount in the specific shot area can be made almost uniform as in other shot areas each having adjacent shots on both sides in the predetermined direction. This makes it possible to reduce the number of dummy shots compared with the conventional method in which dummy exposure is also performed on the adjacent shot on the edge portion side of the specific shot area in the predetermined direction. Therefore, line width uniformity can be ensured almost identically with high precision in the respective shot areas on the substrate, and the throughput can be increased.

In the second scanning exposure method according to the present invention, the predetermined direction can be at least one of a first direction which is a moving direction in which the substrate is moved to expose the specific shot area, and a second direction perpendicular to the first direction. In this case, if the predetermined direction is the first direction (so-called scanning direction), dummy shot can be omitted in an area adjacent to the shot area on the edge portion in the first direction on the substrate. In addition, if the predetermined direction is the second direction, (so-called non-scanning direction) a dummy shot in a region adjacent to the shot area located at the edge portion in the second direction on the substrate can be omitted. Furthermore, if the predetermined direction is both the first and second directions, each of all edge shots at edge portions on the substrate can be the specific shot area, thus all dummy shots can be omitted.

According to the third aspect of the present invention, there is provided a third scanning exposure method of transferring a pattern of a mask onto a plurality of shot areas on a substrate by synchronously moving the mask and the substrate during an exposure of each of the shot areas, comprising, partially changing a target exposure amount with respect to the substrate while exposing a specific shot area of the plurality of shot areas where there is no adjacent shot area in a predetermined direction.

According to this method, when a pattern of a mask is to be transferred onto a plurality of shot areas on a substrate by synchronously moving the mask and substrate, the exposure amount with respect to the substrate in exposing a specific shot area of the plurality of short areas which has no adjacent shot area in a predetermined direction is partially changed in order to correct the exposure amount distribution in the specific shot area. As a consequence, the exposure amount uniformity in the specific shot area is improved.

In this case, the exposure amount can be partially changed with respect to the substrate in consideration of an influence of scattered light caused when the substrate is exposed. In this case, the exposure amount in a specific shot area in exposure can be adjusted in consideration of an influence of unnecessary scattered light produced when the substrate is exposed. This corrects the exposure amount distribution in the specific shot area.

In the third scanning exposure method according to the present invention, the predetermined direction can be at least one of a first direction which is a moving direction of the substrate on exposing the specific shot area, and a second direction perpendicular to the first direction. In this case, if the predetermined direction is the first direction (so-called scanning direction) a dummy shot in an area adjacent to the shot area on the edge portion in the first direction on the substrate can be omitted. In addition, if the predetermined direction is the second direction, (so-called non-scanning direction) a dummy shot in an area adjacent to the shot area on the edge portion in the second direction on the substrate can be omitted. Furthermore, if the predetermined direction is both the first and second directions, each of all edge shots on edge portions on the substrate can be the specific shot area, thus, all dummy shots can be omitted.

According to the fourth aspect of the present invention, there is provided a fourth scanning exposure method of transferring a pattern formed on a mask onto a substrate through a projection optical system while illuminating the mask with an exposure light and synchronously moving the mask and the substrate, which method comprises: performing exposure amount adjustment with respect to the substrate in accordance with information of a transfer error of a pattern line width in a moving direction in which the substrate is moved, when the mask and the substrate are synchronously moving to transfer the pattern on the mask onto a shot area on the substrate.

In this case, the transfer error includes a drawing error in a pattern formed on the mask, an error due to a factor that does not originate from the exposure apparatus itself and shows no difference between exposure apparatus, e.g., the unevenness of thickness of a sensitive film (photosensitive film) on the substrate, a focus control error between an image plane of the projection optical system and an exposure area on a shot area, synchronous movement control error caused between the mask and the substrate, and an error due to a factor that originates from the exposure apparatus itself and varies between exposure apparatuses, e.g., the variety of exposure amount in the shot area due to scattered light caused by the projection optical system.

In the fourth scanning exposure method according to the present invention, the transfer error of a pattern line width which occurs in the scanning direction due to one of the factors described above or a combination of the factors can be suppressed by controlling the exposure amount in the moving direction (scanning direction) of the substrate in exposure by utilizing the facts that the line width of a pattern transferred onto the substrate changes with a change in exposure amount and the exposure amount can be controlled quickly with high precision during synchronous movement. Therefore, the line width distribution uniformity in the scanning direction can be maintained with high precision. In this case, if a line width is determined for which uniformity is to be improved, and a line width distribution is unified with respect to this line width, the distribution can be uniform with a very high precision with respect to the specific line width.

In the fourth scanning exposure method according to the present invention, the exposure amount adjustment described above is preferably changed in accordance with the type of resist (e.g., photoresist) coated on the substrate. In such a case, since the exposure amount is adjusted in accordance with sensitivity that varies depending on the type of resist, pattern line widths can be unified even if a plurality of types of resists are selectively used in accordance with the type of device to be manufactured, or for exposure on the respective layers in multilayer exposure. In addition, the above exposure mount adjustment can be changed depending on the moving direction of the substrate. In this case, since the exposure amount is adjusted in accordance with differences in focus control error due to differences in deformation or vibration of the exposure apparatus in the moving direction of the substrate on exposure, pattern line widths can be made more uniform.

In the fourth scanning exposure method according to the present invention, the pattern can be transferred onto one shot area or a plurality of shot areas on the substrate

If a plurality of shot areas are arranged, the exposure amount adjustment described earlier can be changed depending on a position of the shot area on the substrate. In such a case, for example, the transfer error of a pattern line width due to the uneven thickness of a resist on the substrate which originates from the step of coating the resist in accordance with the size of a shot area can be corrected. Hence, pattern line widths can be uniform.

In this exposure method, the exposure amount adjustment described above can be performed in further consideration of a positional relationship with neighboring shot areas. In this case, for example, pattern line width uniformity differing from the influence of the fog exposure which is caused by flare as described above and depends on whether there are any adjacent shot areas, can be improved.

In the fourth scanning exposure method according to the present invention, the information of the transfer error can include information of a transfer error of a line width of a line pattern substantially parallel to the moving direction of the substrate on exposure. The information can also include a transfer error of a line width of a line pattern that intersects the moving direction of the substrate on exposure. The direction intersecting the moving direction of the substrate in exposure can be a direction almost perpendicular to the moving direction of the substrate on exposure. In this case, the line widths of patterns in the direction of subject can be uniformed.

Furthermore, the information of the transfer error includes information of a transfer error of a line width of a line pattern substantially parallel to the moving direction of the substrate on exposure and information of a transfer error of a line width of a line pattern perpendicular to the moving direction of the substrate on exposure. In such cases, the overall line widths of patterns transferred onto the substrate can be uniformed. The overall line widths of patterns transferred onto the substrate, can be unified by adjusting the uniformed weight of a line width of a line pattern parallel to the moving direction of the substrate on exposure and the uniformed weight of a line width of a line pattern substantially perpendicular to the moving direction of the substrate on exposure.

In the fourth scanning exposure method according to the present invention, the information of the transfer error can be obtained in advance as a transfer error distribution, based on a measurement result on a line width of a pattern transferred onto a predetermined substrate while an exposure amount is kept constant. In addition, this transfer error information can be information on each respective factor described above, which is necessary on calculating the transfer error of a pattern line width in the scanning direction.

In the fourth scanning exposure method according to the present invention, when the exposure light is a pulse light emitted from a pulse illumination light source, the exposure amount adjustment can be performed by controlling at least one of an oscillation frequency of the pulse illumination light source and energy of the pulse illumination light. In addition, when the exposure light is a continuous light emitted from a continuous light source, the exposure amount adjustment can be performed by controlling at least one of energy of a continuous light and a transmittance control element arranged on an optical path of the exposure light. Furthermore, regardless of the type of light source, the exposure amount can be controlled by changing at least one of a moving velocity of the substrate, and a width of exposure area on the substrate in the moving direction of the substrate.

According to the fifth aspect of the present invention, there is provided a fifth scanning exposure method of respectively transferring a pattern of a mask onto a plurality of shot areas on a substrate by synchronously moving the mask and the substrate during an exposure of each of the shot areas, which method comprises, changing exposure amount control during scanning exposure, depending on whether a shot area of the plurality of shot areas lack at least one of an adjacent shot area or has all adjacent shot areas.

According to this method, differences in line width uniformity can be reduced by changing the exposure amount control during scanning exposure in accordance with whether there is at least one adjacent shot area. The differences in line width occur depending on whether there is a portion influenced by fog exposure component produced by scattered light in exposing an at least one adjacent shot area. Accordingly, line width uniformity can be secured similarly with high precision in the respective shot areas on the substrate, and the number of dummy shots can be reduced. This makes increasing the throughput possible.

According to the sixth aspect of the present invention, there is provided a sixth scanning exposure method of respectively transferring a pattern of a mask onto a plurality of shot areas on a substrate by synchronously moving the mask and the substrate during an exposure of each of the shot areas, which method comprises, performing scanning exposure on a specific shot area of the plurality of shot areas while performing exposure amount control in consideration of an influence of flare.

According to this method, in transferring a pattern onto a specific shot area, scanning exposure is performed while exposure amount control is performed in consideration of the influence of flare. This makes it possible to reduce the influence of fog exposure on line width uniformity. Therefore, line width uniformity in the respective shot areas on the substrate can be secured with high precision.

In the sixth scanning exposure method according to the present invention, the specific shot can be an area that lacks at least one of an adjacent shot area. In this case, since the number of dummy shots for ensuring line width uniformity in specific shot areas can be reduced, the throughput can be increased.

According to the seventh aspect of the present invention, there is provided a scanning exposure apparatus for sequentially transferring a pattern formed on a mask onto a plurality of shot areas on a substrate by synchronously moving the mask and the substrate during exposure for each of the shot areas, the apparatus comprising: an illumination system which includes a light source and illuminates the mask with an illumination light for exposure; a projection optical system to project the illumination light for exposure emitted from the mask onto the substrate; a mask stage to hold the mask; a substrate stage to hold the substrate; a driving unit to synchronously move the mask stage and the substrate stage; and a control unit to adjust an exposure amount in a specific shot area located at an edge portion on the substrate such that the exposure amount at the edge portion located on a side that lack an adjacent shot differs from the exposure amount at a remaining portion in the specific shot area.

According to this method, the pattern formed in an area on the mask irradiated with exposure light from the light source through the illumination system is projected onto the substrate through the projection optical system. In addition, the mask stage and substrate stage, are synchronously moved in the scanning direction by the driving unit. As a consequence, the mask and substrate synchronously moves in the scanning direction and the pattern formed on the mask is transferred onto the shot area on the substrate. In this case, in a specific shot area located at an edge portion on the substrate, the control unit performs exposure amount adjustment so that the exposure amount at the edge portion of the specific shot area, located on a side that lack an adjacent shot differs from the exposure amount at the remaining portion. Since a pattern formed on a mask can be transferred onto a shot area on a substrate by using one of the first to third, fifth, and sixth scanning exposure methods of the present invention, the number of dummy shots can be reduced while the exposure amount in each specific shot area can be made almost uniform as in other shot areas. That is, line width uniformity can be identically ensured with high precision in the respective shot areas on the substrate, and the throughput can be increased.

According to the eighth aspect of the present invention, there is provided a scanning exposure apparatus for transferring a pattern formed on a mask onto a substrate while synchronously moving the mask and the substrate, the apparatus comprising: an illumination system which includes a light source and illuminates the mask with an illumination light for exposure; a projection optical system to project the illumination light for exposure emitted from the mask onto the substrate; a mask stage to hold the mask; a substrate stage to hold the substrate; a driving unit to synchronously move the mask stage and the substrate stage; a storage device to store information about a pattern line width transfer error in a synchronous moving direction of the substrate; and a control unit to adjust an exposure amount in the moving direction of the substrate on exposure based on the information, when the mask and the substrate are synchronously moving to transfer the pattern on the mask onto a shot area on the substrate.

According to this method, the pattern formed in an area on the mask, which is irradiated with exposure light from the light source through the illumination system, is projected onto the substrate through the projection optical system. The mask stage and substrate stage are synchronously driven by the driving unit which synchronously drives the mask and substrate, and the pattern formed on the mask is transferred onto a shot area on the substrate. In transferring the pattern onto the substrate, the control system controls the exposure amount based on data corresponding to an exposure amount target value set at a position in each shot area in the moving direction (scanning direction) of the substrate and stored in the storage device. Therefore, the pattern formed on the mask can be transferred onto a shot area on the substrate by using the fourth scanning exposure method. This makes it possible to perform high-precision pattern transfer while ensuring line width distribution uniformity in the moving direction of the substrate.

According to the ninth aspect of the present invention, there is provided a method of making a scanning exposure apparatus for sequentially transferring a pattern formed on a mask onto a plurality of shot areas on a substrate by synchronously moving the mask and the substrate during exposure for each of the shot areas, the method comprising: providing an illumination system which includes a light source and illuminates the mask with an illumination light for exposure; providing a projection optical system to project illumination light for exposure emitted from the mask onto the substrate; providing a mask stage to hold the mask; providing a substrate stage to hold the substrate; providing a driving unit to synchronously move the mask stage and the substrate stage; and providing a control unit to adjust an exposure amount in a specific shot area located at an edge portion on the substrate such that the exposure amount at the edge portion located on a side that lack an adjacent shot differs from the exposure amount at a remaining portion in the specific shot area. According to this method, a first scanning exposure apparatus of the present invention can be made by mechanically, optically, and electrically assembling an illumination system, mask stage, substrate stage, driving unit, control unit, and other various components and adjusting the apparatus.

According to the tenth aspect of the present invention, there is provided a method of making a scanning exposure apparatus for transferring a pattern formed on a mask onto a substrate by synchronously moving the mask and the substrate during exposure for each of the shot areas, the apparatus comprising: providing an illumination system which includes a light source and illuminates the mask with an illumination light for exposure; providing a projection optical system to project the illumination light for exposure emitted from the mask onto the substrate; providing a mask stage to hold the mask; providing a substrate stage to hold the substrate; providing a driving unit to synchronously move the mask stage and the substrate stage; providing a storage device to store information about a pattern line width transfer error in a synchronous moving direction of the substrate; and providing a control unit to adjust an exposure amount in the moving direction of the substrate on exposure based on the information, when the mask and the substrate are synchronously moving to transfer the pattern on the mask onto a shot area on the substrate. According to this method, a second scanning exposure apparatus of the present invention can be made by mechanically, optically, and electrically assembling an illumination system, mask stage, substrate stage, driving unit, control unit, and other various components and adjusting the apparatus.

A device having a fine pattern can be manufactured by forming a predetermined pattern on a substrate by exposing the substrate using the scanning exposure apparatus of the present invention in a lithography process, i.e., using the scanning exposure method of the present invention. According to another aspect, it can be said that the present invention is a device manufactured by using the scanning exposure apparatus of the present invention, i.e., the scanning exposure method of the present invention, and a device manufacturing method of transferring a predetermined pattern onto the substrate in a lithography process by using the scanning exposure apparatus of the present invention, i.e., the scanning exposure method of the present invention.

### BRIEF DESCRIPTION OF THE DRAWINGS

In the accompanying drawings:

FIG. 1 is a view schematically showing the arrangement of a scanning exposure apparatus according to the first embodiment;

FIG. 2 is a view showing the internal arrangement of an excimer laser light source in FIG. 1;

FIG. 3 is a flow chart showing a control algorithm executed by the CPU in a main controller when a reticle pattern is exposed on a plurality of shot areas on a wafer in the first embodiment;

FIG. 4A is a plan view of a specific shot area, and FIGS. 4B to 4D are diagrams for explaining how exposure amount control on the shot area is performed;

FIG. 5 is a view showing an example of the arrangement of shot areas on a wafer W on which exposure on specific shot areas S (S2, S3, S4, S5, S64, S65, S66, and S67) are performed by alternately changing the scanning direction on exposure of each shot area while using the exposure amount control method in FIGS. 4B to 4D;

FIG. 6 is a flow chart for explaining an embodiment of a device manufacturing method using the exposure apparatus shown in FIG.1;

FIG. 7 is a flow chart showing processing in step 204 in FIG. 6;

FIG. 8 is a flow chart showing processing for determining an exposure amount in each shot area in the scanning direction in the second embodiment;

FIG. 9 is a graph showing an example of a measured line width distribution W[m, n] (i, j);

FIG. 10 is a graph showing an example of a line width distribution W[m, n] (Y) obtained by averaging line width distributions W[m, n] (i, j) in the X direction;

FIG. 11 is a graph showing an example of a line width distribution W[n] (Y, E);

FIG. 12 is a graph showing an example of an exposure amount E[n] (Y) as a target line width at each Y position;

FIGS. 13A to 13C are views for explaining the prior art; and

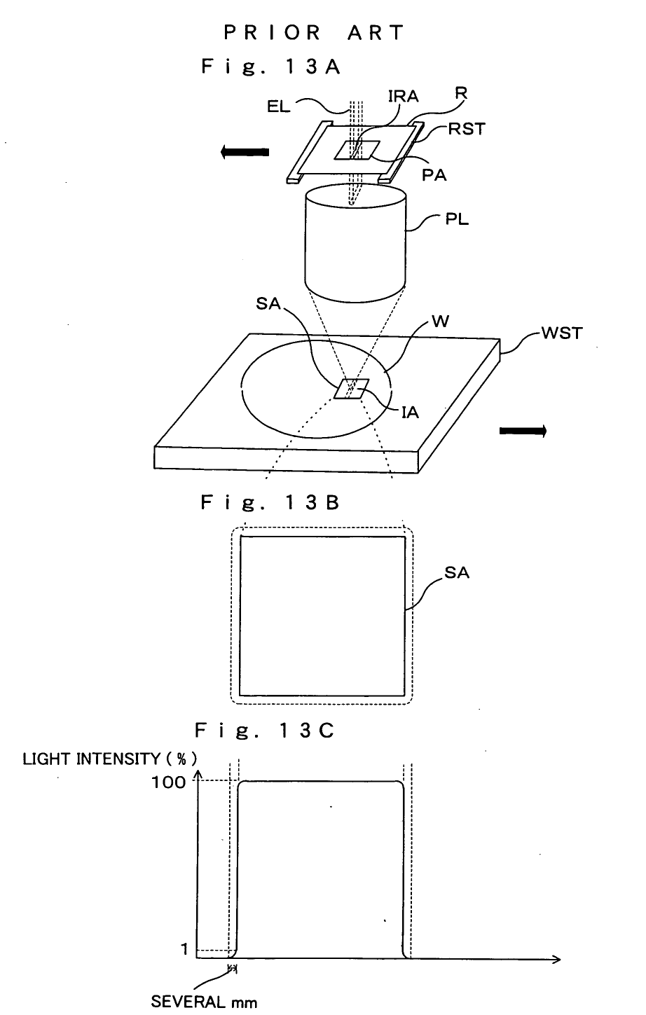

FIG. 14 is a view for explaining an example of the arrangement of shot areas and dummy shot areas according to the prior art.

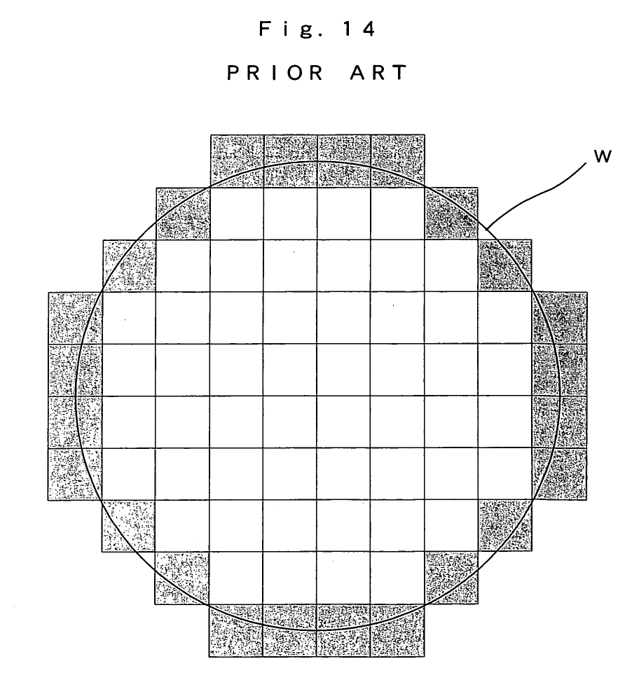

### DESCRIPTION OF THE PREFERRED EMBODIMENTS

### First Embodiment

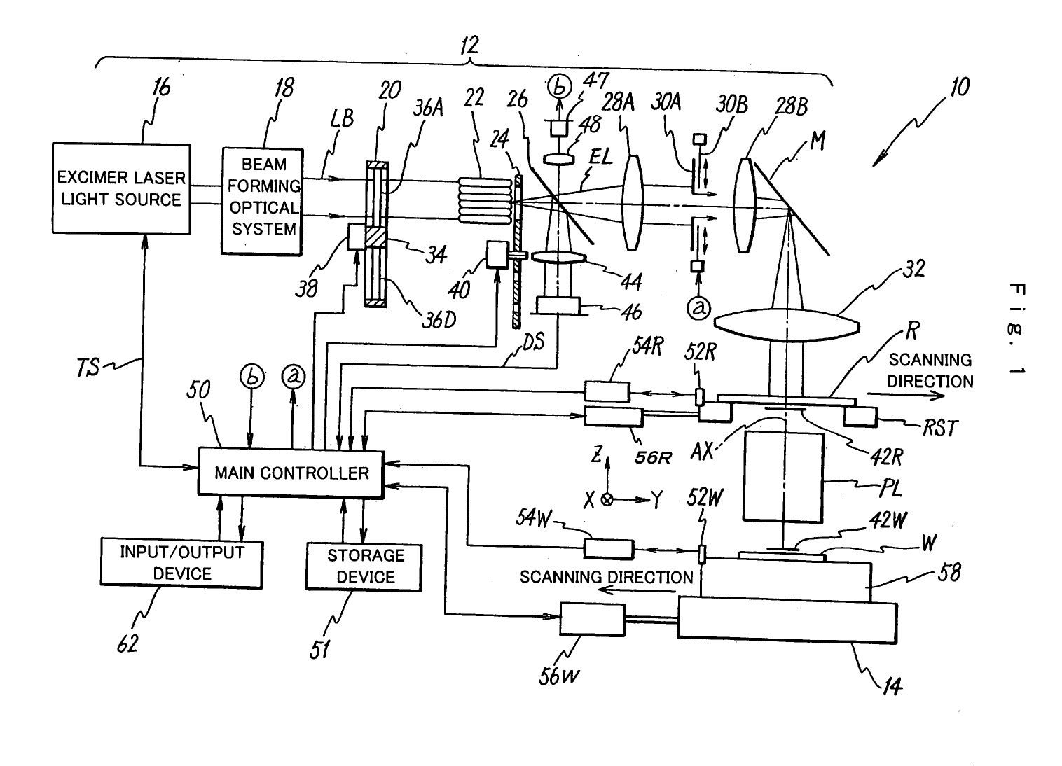

The first embodiment of the present invention will be described below with reference to the FIGS. 1 to 5.

FIG. 1 shows the schematic arrangement of a scanning exposure apparatus 10 according to an embodiment. This scanning exposure apparatus 10 is a scanning exposure apparatus based on the step-and-scan method using an excimer laser light source as a pulse laser light source for an exposure light source.

The scanning exposure apparatus 10 comprises an illumination system 12 including an excimer laser light source 16, a reticle stage RST serving as a mask stage for holding a reticle R as a mask illuminated with exposure illumination light EL from the illumination system 12, a projection optical system PL for projecting the exposure illumination light EL, emitted from the reticle R onto a wafer W as a substrate, an X-Y stage 14 on which a Z tilt stage 58 serving as a substrate stage for holding the wafer W is mounted, and a control system for these components.

The illumination system 12 comprises the excimer laser light source 16, a beam shaping optical system 18, a rough energy adjuster 20, a fly-eye lens 22, an illumination system aperture stop plate 24, a beam splitter 26, a first relay lens 28A, a second relay lens 28B, a fixed reticle blind 30A, a movable reticle blind 30B, a deflection mirror M for bending an optical path, a condenser lens 32, and the like.

Each component of the illumination system 12 will be described below. As the excimer laser light source 16, one of the following laser light sources is used: a KrF excimer laser light source (wavelength: 248 nm), ArF excimer laser light source (wavelength: 193 nm), F₂ laser light source (wavelength: 157 nm), Kr₂ (krypton dimer) laser light source (wavelength: 146 nm), Ar₂ (argon dimer) laser light source (wavelength: 126 nm), and the like. Alternatively, a pulse light source such as a metal vapor laser light source or harmonic generator of YAG laser may be used as an exposure light source as the excimer laser light source 16.

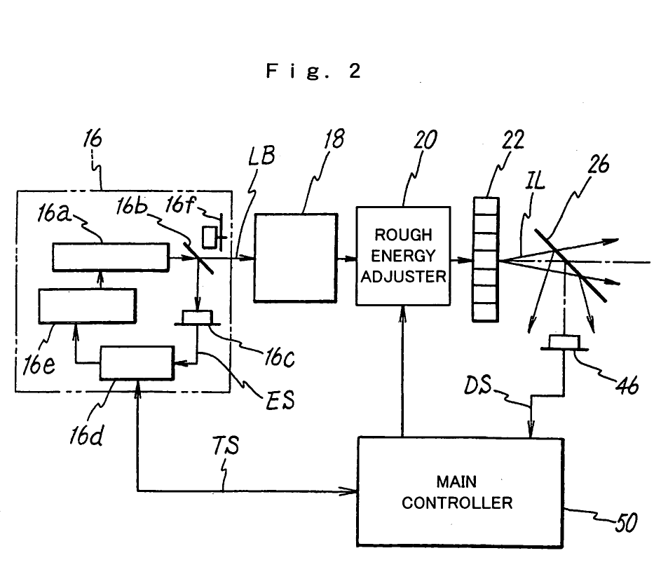

FIG. 2 shows the internal arrangement of the excimer laser light source 16, together with a main controller 50. The excimer laser light source 16 includes a laser resonator 16a, beam splitter 16b, energy monitor 16c, energy controller 16d, high-voltage power supply 16e, and the like.

A laser beam LB emitted in the form of pulse light from the laser resonator 16a is incident on the beam splitter 16b having a high transmittance and a low reflectivity. The laser beam LB transmitted through the beam splitter 16b is emitted outside. The laser beam LB reflected by the beam splitter 16b is incident on the energy monitor 16c formed by a photoelectric converter, and a photoelectric conversion signal from the energy monitor 16c is sent as an output ES to the energy controller 16d through a peak holder (not shown in FIGS.).

When a pulse laser beam is emitted, the energy controller 16d controls the power supply voltage of the high-voltage power supply 16e by feedback control. By this control, the value of the output ES from the energy monitor 16c becomes a value corresponding to a target value of energy per pulse in control information TS sent from the main controller 50. In addition, the energy controller 16d controls the energy of a laser beam emitted from the laser resonator 16a by pulse emission through the high-voltage power supply 16e, and also changes the oscillation frequency (pulse frequency) of the laser resonator 16a. The energy controller 16d sets the oscillation frequency of the excimer laser light source 16 to a frequency designated by the main controller 50 in accordance with the control information TS from the main controller 50. The controller 16d also controls the power supply voltage of the high-voltage power supply 16e by feedback control, such that the energy per pulse in the excimer laser light source 16 becomes a value instructed by the main controller 50. A shutter 16f for shielding the laser beam LB in accordance with control information from the main controller 50 is arranged outside the beam splitter 16b in the excimer laser light source 16.

The details of exposure amount control to be performed when scanning exposure is performed by using a laser beam generated by pulse emission are disclosed in, for example, in Japan Patent Laid Open No. 08-250402 and U.S. Pat. No. 5,448,332 corresponding thereto. The above disclosures are fully incorporated by reference herein.

In this embodiment, the energy of a laser beam is controlled in units of pulses by using the energy monitor in the laser light source, as described above. However, the high-voltage power supply 16e can be controlled in units of pulses by directly using energy information of each pulse of a laser beam detected by an integrator sensor 46 (to be described later).

Referring back to FIG. 1, the beam shaping optical system 18 forms the cross-sectional shape of the laser beam LB emitted from the excimer laser light source 16 by pulse emission to allow the laser beam LB to be efficiently incident on the fly-eye lens 22. The fly-eye lens 22 is arranged downstream of the optical path of the laser beam LB. For example, the beam shaping optical system 18 comprises a cylinder lens or beam expander (neither is shown in FIGS.).

The rough energy adjuster 20 is arranged on the optical path of the laser beam LB behind the beam shaping optical system 18. In this case, a plurality of (e.g., six) ND filters (FIG. 1 shows two ND filters 36A and 36D of the ND filters) having different transmittances (=1—attenuation ratio) are arranged around a rotating plate 34. The transmittance with respect to the incident laser beam LB can be switched in steps from 100% in a geometric series manner by rotating the rotating plate 34 using a driving motor 38. The driving motor 38 is controlled by the main controller 50 (described later). The transmittance maybe adjusted more finely by preparing another rotating plate identical to the rotating plate 34, and combining them with two sets of ND filters.

The fly-eye lens 22 is located on the optical path of the laser beam LB emitted from the rough energy adjuster 20, and forms many secondary sources so as to illuminate the reticle R with light having a uniform illuminance distribution. A laser beam emitted from each secondary light source will be referred to as “pulse illumination light EL” hereinafter.

The illumination system aperture stop plate 24 formed of a disk-like member and used for modifying illumination is arranged near the emerging surface of the fly-eye lens 22. For example, the following aperture stops (only two types of aperture stops are shown in FIG. 1) are formed in the illumination system aperture stop plate 24 at equal angular intervals: an aperture stop of which shape is ordinary, an aperture stop formed of a small circular aperture for reducing the σ value which is a coherence factor, an ring-shaped aperture stop for ring-shaped illumination, and a plurality of apertures(for example, four) of which each central position differ from the optical axis position for a modified illumination. The illumination system aperture stop plate 24 is rotatably driven by a driving unit 40 such as a motor which controlled by the main controller 50 (to be described later) With this operation, one of the aperture stops is selectively set on the optical path of the pulse illumination light EL.

The modifying illumination is disclosed in Japan Patent Laid Open No. 05-304076, U.S. Pat. No. 5,335,044 corresponding thereto, Japan Patent Laid Open No. 07-94393, and U.S. Pat. No. 5,661,546 corresponding thereto. The above disclosures are fully incorporated by reference herein.

The beam splitter 26 having a low reflectivity and a high transmittance is arranged on the optical path of the pulse illumination light EL emerging from the illumination system aperture stop plate 24. In addition, a relay optical system constituted by the first and second relay lenses 28A and 28B with the fixed reticle blind 30A and movable reticle blind 30B arranged in between the lenses along the optical path, is arranged behind the beam splitter 26.

The fixed reticle blind 30A is arranged on a plane that is slightly defocused from a plane conjugated to the pattern surface of the reticle R, and has a rectangular opening for determining an illumination area 42R on the reticle R. The movable reticle blind 30B is disposed near the fixed reticle blind 30A, and has an opening portion variable in position and width in the scanning direction. At the start and end of scanning exposure, the illumination area 42R is further restricted through the movable reticle blind 30B to prevent exposure on an unnecessary portion.

The deflection mirror M for reflecting the pulse illumination light EL transmitted through the second relay lens 28B toward the reticle R is arranged downstream of the second relay lens 28B on the optical path of the pulse illumination light EL of the relay optical system. The condenser lens 32 is arranged on the optical path of the pulse illumination light EL further downstream of the deflection mirror M.

In addition, the integrator sensor 46, structured by a photoelectric converter is arranged on one side of the optical path vertically bent by the beam splitter 26 in the illumination system 12. On the other of the optical path, a reflected light monitor 47 is arranged. As the integrator sensor 46 and reflected light monitor 47, for example, PIN photodiodes and the like that have sensitivity in the far-ultraviolet range and high response frequencies to detect pulse emissions from the excimer laser light source 16 can be used.

The operation of the illumination system 12 having this arrangement will be briefly described below. The laser beam LB emitted from the excimer laser light source 16 by pulse emission is incident on the beam shaping optical system 18, in which the cross-sectional shape of the laser beam LB is shaped such that the laser beam can be efficiently incident on the fly-eye lens 22. The laser beam LB is then incident on the rough energy adjuster 20. The laser beam LB is transmitted through one of the DN filters of the rough energy adjuster 20 and incident on the fly-eye lens 22. With this operation, many secondary light sources are formed at the exit end of the fly-eye lens 22. The pulse illumination light EL as exposure light (exposure illumination light) emerging from these many secondary light sources passes through one of the aperture stops on the illumination system aperture stop plate 24 and reaches the beam splitter 26 having a high transmittance and a low reflectivity. The pulse illumination light EL transmitted through the beam splitter 26 passes through the rectangular opening portion of the fixed reticle blind 30A and movable reticle blind 30B through the first relay lens 28A. The pulse illumination light EL then passes through the second relay lens 28B, and its optical path is vertically bent downward by the deflection mirror M. Thereafter, the pulse illumination light EL passes through the condenser lens 32 and illuminates the rectangular illumination area 42R on the reticle R, held on the reticle stage RST, with a uniform illuminance distribution.

The pulse illumination light EL reflected by the beam splitter 26 proceeds through a condenser lens 44 and is received by the integrator sensor 46. A photoelectric conversion signal (information about the energy of each pulse of pulse illumination light) from the integrator sensor 46 is sent as an output DS (digit/pulse) to the main controller 50 through a peak holder and A/D converter (neither is shown in FIGS.). The correlation coefficient between the output DS from the integrator sensor 46 and the light intensity (illuminance) of the pulse illumination light EL on the surface of the wafer W is obtained in advance and stored in a memory (storage device) 51 connected to the main controller 50.

The light beam that illuminates the illumination area 42R on the reticle R is reflected on the pattern surface (the lower surface in FIG. 1) of the reticle, passes through the condenser lens 32 and relay optical system in a direction opposite to the direction in which it traveled before. It is, then, reflected on the beam splitter 26 to be received by the reflected light monitor 47 through a condenser lens 48. A photoelectric conversion signal from the reflected light monitor 47 is sent to the main controller 50 through the peak holder and A/D converter (neither is shown). The reflected light monitor 47 is mainly used to measure the transmittance of the reticle R in advance in this embodiment. This operation will be described later.

The reticle R is held on the reticle stage RST by suction, through a vacuum chuck or the like. The driving portion 56R drives the reticle stage RST, finely in a predetermined stroke range within a horizontal plane (X-Y plane). It can also be driven in the scanning direction (the Y direction, which is the lateral direction on the drawing surface of FIG. 1 in this case). The position of the reticle stage RST during this scanning operation is measured by an external laser interferometer 54R through a movable mirror 52R fixed on the reticle stage RST. The measurement value obtained by this laser interferometer 54R is sent to the main controller 50.

Material for the reticle R need to be selectively chosen, depending on the light source to be used. More specifically, if a KrF excimer laser light source or ArF excimer laser light source is used as the light source, synthetic quartz can be used. If, however, an F₂ laser light source is used, the reticle R must be made of fluorite.

The projection optical system PL is structured of a plurality of lens elements that have a common optical axis AX in the Z-axis direction, and forms an optical arrangement which is telecentric on both sides. In addition, as this projection optical system PL, an optical system which projection magnification β is, for example, ¼ or ⅕ is used. Consequently, when the illumination area 42R on the reticle R is illuminated with the pulse illumination light EL in the manner described above, projection exposure is performed of an image of a pattern formed on the reticle R which is reduced by the projection optical system PL at the projection magnification β onto a slit-like exposure area 42W on the wafer W coated with a resist (photosensitive agent).

When a KrF excimer laser beam or ArF excimer laser beam is used as the pulse illumination light EL, synthetic quartz or the like can be used for the respective lens elements structuring the projection optical system PL. When, however, an F₂ laser beam is used, fluorite alone is used as a material for the lenses used for this projection optical system PL.

The X-Y stage 14 is two-dimensionally driven, within the X-Y plane in the Y direction which is the scanning direction, and the X direction (perpendicular to the drawing surface of FIG. 1) perpendicular to the Y direction by a wafer stage driving portion 56W. The wafer W is held via a wafer holder (not shown in FIGS.) on a Z tilt stage 58 mounted on the X-Y stage 14, by vacuum chucking or the like. The Z tilt stage 58 has the function of adjusting the Z-direction position (focal position) of the wafer W, and also adjusting the tilt angle of the wafer W with respect to the X-Y plane. The position of the X-Y stage 14 is measured by an external laser interferometer 54W through a movable mirror 52W fixed on the Z tilt stage 58. The measurement value obtained by this laser interferometer 54W is sent to the main controller 50.

The scanning exposure apparatus 10 shown in FIG. 1 further includes a multiple focal position detection system as one of the focus detection systems based on the oblique incident light method. This system is used to detect the positions of a portion in the exposure area IA on the surface of the wafer W and its neighboring area in the Z direction (the direction of the optical axis AX). This multiple focal position detection system is structured of a light-emitting system and light-receiving system (not shown). The detailed arrangement or the like of this multiple focal position detection system is disclosed in, for example, Japan Patent Laid Open No. 06-283403 and U.S. Pat. No. 5,448,332 corresponding thereto. The above disclosures are incorporated by reference herein.

Referring to FIG. 1, the control system is mainly structured by the main controller 50 serving as a control unit. The main controller 50 includes a so-called microcomputer (or workstation) configured of a CPU (Central Processing Unit), ROM (Read Only Memory), RAM (Random Access Memory), and the like. It systematically controls synchronous scanning of the reticle R and wafer W, stepping of the wafer W, exposure timing, and the like to accurately perform exposure. In this embodiment, the main controller 50 also controls the exposure amount in scanning exposure, as will be described later.

More specifically, in scanning exposure, the main controller 50, for example, controls the position and speed of the reticle stage RST and X-Y stage 14 via the reticle stage driving portion 58R and wafer stage driving portion 56W, based on the measurement values obtained by the laser interferometers 54R and 54W. The wafer W is scanned with respect to the exposure area 42W in the −Y direction (or +Y direction) at a velocity Vw=β·V (β is the projection magnification of the reticle R with respect to the wafer W) through the X-Y stage 14 in synchronism with scanning of the reticle R in the +Y direction (or −Y direction) at a velocity Vr=V through the reticle stage RST. On stepping operation, the main controller 50 controls the position of the X-Y stage 14 via the wafer stage driving portion 56W based on the measurement value obtained by the laser interferometer 54W. As described above, in the first embodiment, the main controller 50, laser interferometers 54R and 54W, reticle stage driving portion 56R, and wafer stage driving portion 56W configure a driving unit for synchronously moving the reticle stage RST and Z tilt stage 58 in the scanning direction.

Furthermore, the main controller 50 controls the oscillation frequency (emission timing), emission power (energy), and the like of the excimer laser light source 16 by sending the control information TS to the excimer laser light source 16. The main controller 50 controls the rough energy adjuster 20 and illumination system aperture stop plate 24 through the driving motor 38 and driving unit 40, respectively, and also controls the opening/closing operation of the movable reticle blind 30B in synchronism with the stage operation information.

As described above, in this embodiment, the main controller 50 also serves as an exposure controller and stage controller. Obviously, however, these controllers may be prepared independently of the main controller 50.

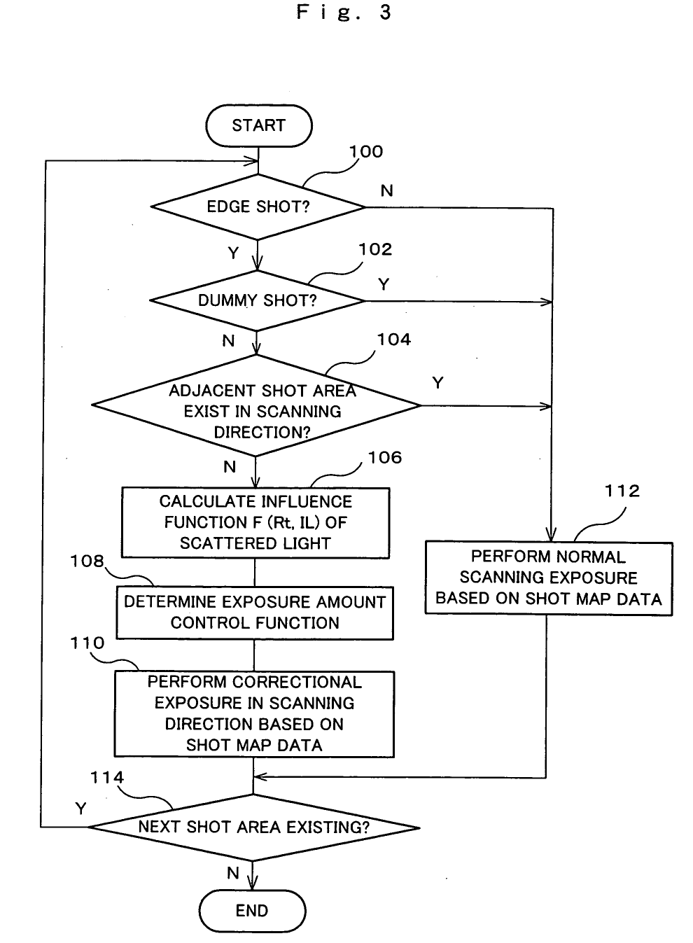

An exposure sequence for exposure of a reticle pattern on a plurality of shot areas on the wafer W in the scanning exposure apparatus 10 according to this embodiment that has the above arrangement, will be described with reference to the flow chart of FIG. 3 showing a control algorithm for the CPU in the main controller 50.

First, premises will be described.

\mathring{1} The shot map data (data defining the exposure order and scanning directions of the respective shot areas) has been generated based on the shot array (including several dummy shots), shot size, the exposure order of the respective shots, and other necessary data, which are input by an operator through an input/output unit 62 (see FIG. 1) such as a console, and is to be stored in the memory 51 (see FIG. 1).

\mathring{2} The output DS from the integrator sensor 46 has been calibrated in advance with respect to an output from a reference illuminometer (not shown) arranged at the same level as that of an image plane (i.e., a wafer surface) on the Z tilt stage 58. The data processing unit in this reference illuminometer is (mj/(cm²·pulse) ) which is a physical quantity. Calibrating the integrator sensor 46 is equivalent to obtaining a conversion coefficient K1 (or conversion function) for converting the output DS (digit/pulse) from the integrator sensor 46 into the exposure amount (mj/(cm²·pulse)) on the image plane. With the use of this conversion coefficient K1, the exposure amount on the image plane can be indirectly measured from the output DS of the integrator sensor 46.

\mathring{3} The output ES from the energy monitor 16c has also been calibrated with respect to the output DS from the integrator sensor 46 having completed the above calibration, and a correlation coefficient K2 between the two values has been obtained and stored in the memory 51 in advance.

\mathring{4} The output from the reflected light monitor 47 has been also calibrated with respect to the output from the integrator sensor 46 having completed the above calibration, and a correlation coefficient K3 between the two values has been obtained and is to be stored in the memory 51 in advance.

\mathring{5} The main controller 50 sets an aperture stop (not shown in FIGS.) for the projection optical system PL, selects and sets an aperture of the illumination system aperture stop plate 24, selects an attenuation filter of the rough energy adjuster 20, and sets a target exposure amount corresponding to a resist sensitivity, in accordance with an exposure condition including an illumination condition (the numerical aperture NA of the projection optical system, coherence factor σ, pattern type, and the like), which is input by the operator through the input/output unit 62 (see FIG.1) such as a console.

\mathring{6} The reticle transmittance of the reticle R used for exposure has been measured in advance in the following manner, and the measurement result has been stored in the memory 51.

First of all, the reticle R is loaded on the reticle stage RST by a reticle loader (not shown in FIGS.). At this time, the X-Y stage 14 is located at a predetermined loading position away from a position directly below the projection optical system PL, and at this loading position, the wafer on the wafer holder is exchanged. After the reticle R is loaded, the main controller 50 takes into consideration the output from the integrator sensor 46 and reflected light monitor 47, then multiplies the ratio between the two outputs by the correlation coefficient K3, subtracts the result from 1, and multiplies the resultant value by 100, thereby obtaining a transmittance Rt(%) of the reticle R. In this case, since the X-Y stage 14 is not present directly below the projection optical system PL, reflected light from a portion below the projection optical system PL can be regarded as light which light intensity is negligibly low.

The control algorithm in FIG. 3 starts upon completion of a series of preparatory operations for exposure, e.g., wafer exchange, reticle alignment, baseline measurement, search alignment, and fine alignment.

First of all, upon performing scanning exposure on a shot area of a plurality of shot areas determined in the wafer W, in step 100, it is checked whether the shot area as the exposure target is an edge shot. This judgement in step 100, is based on the shot map data (the data defining the shot array, exposure order, scanning direction, and the like in sequentially performing exposure processing on a plurality of shot areas in the wafer W) generated and stored in the memory 51 in advance. If the result is negative in step 100, the flow advances to step 112 to perform scanning exposure on the shot in accordance with the scanning direction in the shot map data in the memory 51. In this case, exposure amount control is performed to make the exposure amount during exposure uniform within the shot as on normal exposure.

If the result is affirmative in step 100, the flow advances to step 102 to check whether the shot area as the exposure target is a predetermined dummy shot. This judgement in step 102 is also performed based on the shot map data stored in the memory 51. If the result is affirmative in step 102, the flow advances to step 112 to perform scanning exposure in the scanning direction based on the shot map data in the memory 51 as in the manner described above.

Meanwhile, if the result is negative in step 102, the flow advances to step 104 to check whether adjacent shots are present on the two sides of the shot in the scanning direction based on the shot map data stored in the memory 51. If the result is affirmative in step 104, that is, the shot area is an edge shot, not a dummy shot, and one of the adjacent shots in the non-scanning direction is lacking, the flow advances to step 112. Then scanning exposure is performed on the shot in the scanning direction based on the shot map data stored in the memory 51. If the result is negative in step 104, the flow advances to step 106 to calculate as the first function, an influence function in a concrete form as a function for evaluating the degree of influence of scattered light.

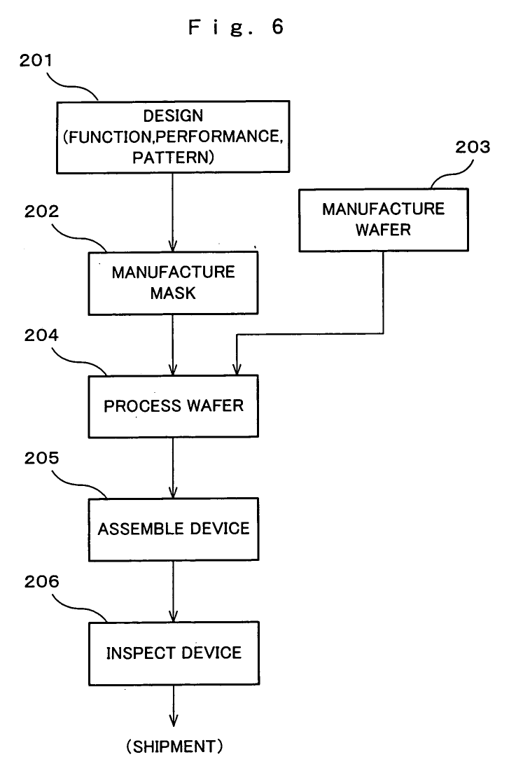

This influence function F is a function obtained in advance by experience, which includes at least the transmittance Rt and illumination condition IL as parameters, and corresponds to the shape of a flare portion that leaks out from the shot area in FIG. 6C in the prior art described above. Following will be a brief description of the parameters Rt and IL.

\mathring{1} Rt: Reticle Transmittance

In the case of a reticle mostly covered with a light-shielding material (e.g., a chromium film), e.g., a reticle for exposure of isolated patterns such as contact holes, the absolute amount of light incident on the projection optical system is small. Therefore, scattering components caused by the material, material surfaces, and coating material in the projection optical system at least becomes relatively small. In this case, the influence of scattered light is almost insignificant.

In contrast to this, in the case of a reticle which light-shielding portion is small in area, e.g., a reticle for exposure of a line-and-space pattern, since some reticles of this type have a transmittance exceeding 50%, the influence of scattered light cannot be neglected. As described above, a maximum of about 1% of scattering components is caused.

Accordingly, is important to include a reticle transmittance as a parameter of the influence function, to accurately obtain the influences of scattered light.

\mathring{2} IL: Illumination Condition and the like

The degree of influence of scattered light varies depending on an illumination condition, more precisely, the numerical aperture N.A of the projection optical system, coherence factor σ, and the type of reticle pattern. This is because, the position of light beams passing through the illumination optical system and projection optical system vary depending on each condition, and hence, scattered light varies in [light intensity] and [the manner of divergence] depending on where the light is scattered in the optical system.

In general, when an illumination system aperture stop having a large numerical aperture is selected, or a large numerical aperture is determined for the projection optical system, or a reticle pattern is fine using light with a large diffraction angle, scattered light tends to become stronger and diverge farther. This is because, the accuracy of finishing, material uniformity, and the like of the optical system tend to deteriorate as the distance from the optical axis of the projection optical system becomes farther off in the radial direction.

The parameters above must be registered for each exposure job before the processing in step 106 in FIG. 3, thus, in this embodiment, as with the reticle transmittance, the settings of illumination conditions are stored in the memory 51 in advance.

As is obvious from the description above, the influence function of scattered light can be expressed as F (light intensity, divergence)=F(Rt, IL). As described above, this function must be obtained by experience and registered in advance. In this embodiment, however, since the issue is whether there is influence of scattered light in exposure of an adjacent shot on one edge portion side of a specific shot area in the scanning direction, the experiment can be conducted as follows.

That is, for example, under a certain exposure condition, the reticle stage RST can be moved to a position where an edge portion of a shot area is exposed in scanning exposure, and stopped at the position. At the position, a pinhole sensor (not shown in FIGS.) (output from this pinhole sensor has been calibrated with respect to the output from the integrator sensor 46) is fixed on the Z tilt stage 58, and a light amount is measured in a measurement target area, having a predetermined area and is adjacent to the outside of the exposure area 42W in the scanning direction while the X-Y stage 14 is moving at predetermined intervals in the X and Y, two-dimensional directions. The output values from the pinhole sensor at the respective Y positions are averaged in the X direction to obtain light intensity distribution data on the wafer surface in the scanning direction (Y direction) within the measurement target region.

Then, the reticle stage RST is moved from the position above toward the center of the shot area of scanning exposure by a predetermined amount up to a position where exposure is performed, and stopped at the position. Light intensity distribution data then, are obtained on the wafer surface in the scanning direction (Y direction) in the measurement target area. The measurement above can be performed by using the slit sensor which output is calibrated, instead of using the output average of the pinhole sensor described above.

Such an experiment is repeatedly performed several times, while the reticle stage is moved a predetermined amount, and an light intensity at each Y direction is obtained from the sum of light intensity at the respective Y positions in the measurement target area. The light intensity distribution data obtained in this manner are subjected to curve fitting. And an influence function curve of scattered light under the exposure condition can be obtained. In order to determine a specific function corresponding to this influence function curve, a value at a representative point of the influence function curve is substituted into a predetermined function including the predetermined parameters Rt and IL and an undefined coefficient. This determines the undefined coefficient, thereby obtaining a specific influence function under the exposure condition.

Such an experiment is repeatedly performed while the reticle transmittance is gradually changed (reticles having different transmittances are exchanged), and further by gradually changing the illumination condition, thereby obtaining a specific influence function for each reticle transmittance and each illumination condition.

The influence function for each exposure condition obtained in the manner above may be stored as a table in the memory 21. Alternatively, the influence function in each exposure condition, obtained as described above, may be statistically processed (e.g., the least square method) to determine an undefined coefficient included in an influence function which is not affected by the exposure conditions, and a general mathematical expression of an influence function can be obtained and stored as an influence function F(Rt, IL) in the memory (storage device) 51. In the following description, this influence function F(Rt, IL) is stored in the memory (storage device) 51 in advance.

In step 106 in FIG. 3, the parameters Rt and IL (obtained by a predetermined computation) are substituted into this influence function and an influence function under the exposure condition is calculated.

In the next step 108, an exposure amount control function is determined based on the influence function obtained in step 106 as described above, and the flow then advances to step 110. The exposure amount control function is to correspond with the position of the reticle during scanning exposure. In step 110, scanning exposure is performed on the exposure target shot area while the exposure amount is controlled in accordance with the exposure amount control function determined in step 108. A detailed example of the exposure amount control will be described later.

After scanning exposure is performed on the shot in either step 112 or step 110, the flow then advances to step 114 to check whether there is a next shot (a shot to be exposed next). If there is a shot to be exposed next, the flow returns to step 100 to repeat the above process and judgement. When exposure on all the shot areas on the wafer W is completed, the result in step 114 becomes affirmative and completes the series of operations in this routine.

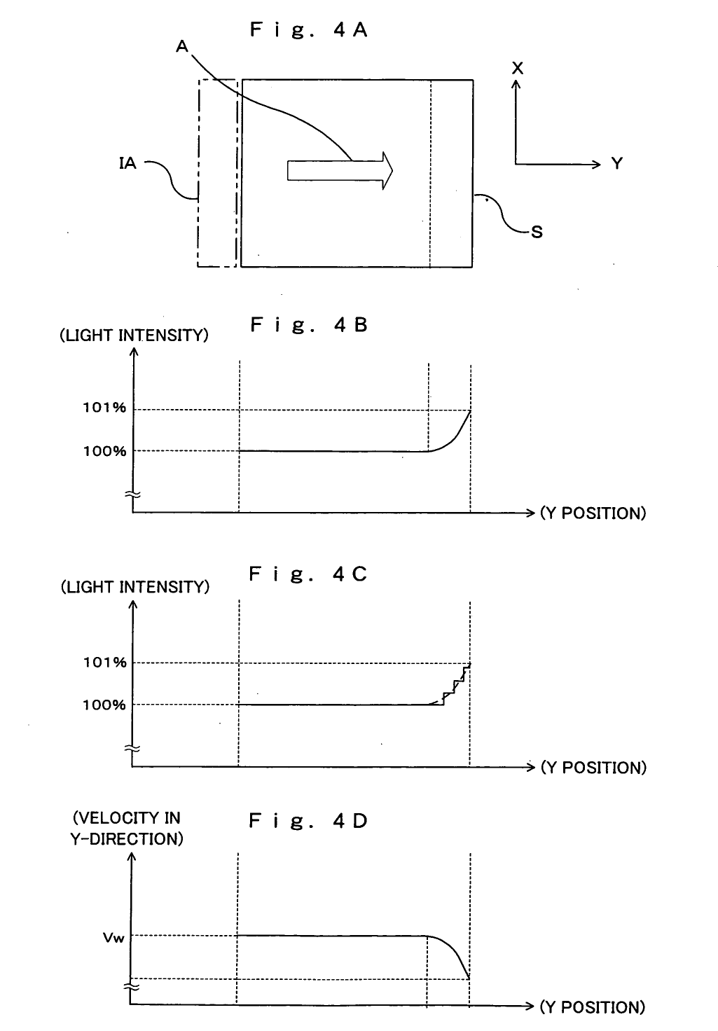

A detailed example of exposure amount control performed during scanning exposure on a specific shot area in step 110 will be described next with reference to FIG. 4.

FIG. 4A is a plan view of a specific shot area (to be referred to as a “shot area S” hereinafter for the sake of convenience) in the case the result obtained in step 104 is affirmative. When this shot area S is exposed, the exposure area IA being indicated by the phantom line (dashed-double-dotted line), is scanned in respect to the wafer in the direction indicated by an arrow A (+Y direction). FIGS. 4B to 4D show how exposure amount control is performed on the shot area S.

FIG. 4B is a diagram showing how the exposure amount changes when the exposure amount is adjusted in accordance with an exposure amount control function. The amount (light intensity) of the illumination light EL applied on the reticle R starts to increase from a point located several mm inward from the edge portion of the shot area S in the +Y direction, and is continuously increased up to the edge portion in the +Y direction. In this case, the influence function F corresponds to this state. In such exposure amount control, the main controller 50 controls the voltage to be applied from the high-voltage power supply 16e of the excimer laser light source 16 to the energy controller 16d. This can be achieved by sending the control information TS corresponding to the determined exposure amount control function to the energy controller 16d, and continuously increases the energy per pulse, thus the exposure amount control can be easily implemented. In addition, a ND filter or the like capable of continuously changing the light amount (light intensity) may be arranged on the optical path of the illumination light EL. Furthermore, the control described above can be easily implemented by continuously increasing the oscillation frequency (pulse frequency) of the laser resonator 16a of the excimer laser light source 16. Apparently, adjustment of the oscillation frequency of the laser resonator 16a may be combined with adjustment of the energy per pulse.

The exposure amount control described above is performed since a side of the specific shot area S (in the +Y direction in this case) lacks an adjacent shot, and fog exposure due to scattered light does not occur at the edge portion of the shot area S. Without exposure amount control, therefore, the exposure amount on the surface of the wafer W gradually decreases toward one edge portion in the scanning direction. Such unevenness in uniformity of exposure amount must be canceled out. So, by the exposure amount control as in FIG. 4B, the uniformity of exposure amount in the shot area S improves, making it possible to ensure that the line width uniformity within the shot area S is equivalent with that of other shot areas interior of the wafer.

When the exposure area IA is to be scanned relative to the shot area S in a direction opposite to the direction indicated by the arrow A, the exposure amount may be adjusted in accordance with an exposure amount control function that starts decreasing the amount of illumination light EL emitted on the reticle R from the edge portion of the shot area S in the +Y direction. The light amount is adjusted so that it continuously decreases to a predetermined target light amount at a point several mm located inward from the edge portion of the shot area S in the +Y direction.

Referring to FIG. 4B, the amount of illumination light EL applied on the reticle R is continuously changed. However, the present invention is not limited to this. As shown in FIG. 4C, the exposure amount can be adjusted in accordance with an exposure amount control function that starts increasing the amount of illumination light EL emitted on the reticle R from a point located several mm inward from the edge portion of the shot area S in the +Y direction. The light amount can be increased step by step, up to the edge portion in the +Y direction. In this case, as compared with the case shown in FIG. 4B, the exposure amount uniformity in the shot area S is not high, however, the exposure amount uniformity becomes much higher than that in the case wherein no exposure amount control is performed.

In addition, since scanning exposure is performed in this embodiment, the exposure amount in this scanning exposure can be adjusted by changing the scanning velocity while maintaining the power (light intensity) and oscillation frequency of the excimer laser light source 16 constant, and keeping the velocity ratio between the reticle stage RST and X-Y stage 14 constant. FIG. 4D shows how the scanning velocity changes in accordance with an exposure amount control function corresponding to this case. In this case, as the scanning velocity increases the exposure amount on the wafer decreases, and as the scanning velocity decreases the exposure amount increases. At the edge portion of the shot area S on the side where it lacks an adjacent shot, the influence caused by the absence of fog exposure must be canceled out by increasing the exposure amount. As is obvious from FIG. 4D, in this case, the main controller 50 may change the scanning velocity of the reticle stage RST and X-Y stage 14 via the reticle stage driving portion 48 and-wafer stage driving portion 56. The velocity is changed, in accordance with an exposure amount control function that starts decreasing the scanning velocity of the reticle stage RST and X-Y stage 14 at a point located several mm inward from the edge portion of the shot area S in the +Y direction. The scanning velocity is continuously decreased up to the edge portion in the +Y direction, while the measurement values obtained by the interferometers 54R and 54W is monitored by the main controller 50. In this case, the exposure amount control function almost corresponds to the inverse function of the influence function F.

Obviously, when the exposure area IA is scanned in respect to the shot area S in a direction opposite to the direction indicated by the arrow A, the scanning velocity may be adjusted in accordance with an exposure amount control function that starts increasing the scanning velocity at the edge portion of the shot area S in the +Y direction. The scanning velocity is continuously increased to a predetermined target scanning velocity at a point located several mm inward from the edge portion of the shot area S in the +Y direction.

The main controller 50 can implement exposure amount control as described above, by controlling the movable reticle blind 30B in the illumination system 12 and continuously changing the width (so-called slit width) of the illumination area 42R (i.e., the exposure area 42W) in the scanning direction. The main controller may adjust the exposure amount by combining adjustment of the scanning velocity with adjustment of the slit width.

As described above, the main controller 50 may adjust the exposure amount by controlling at least one of the oscillation frequency of the laser resonator 16a of the excimer laser light source 16, energy per pulse, scanning velocity, and slit width in accordance with the determined exposure amount control function. In other words, in step 108 described above, the appropriate exposure amount control function may be determined depending on how the exposure amount is controlled.

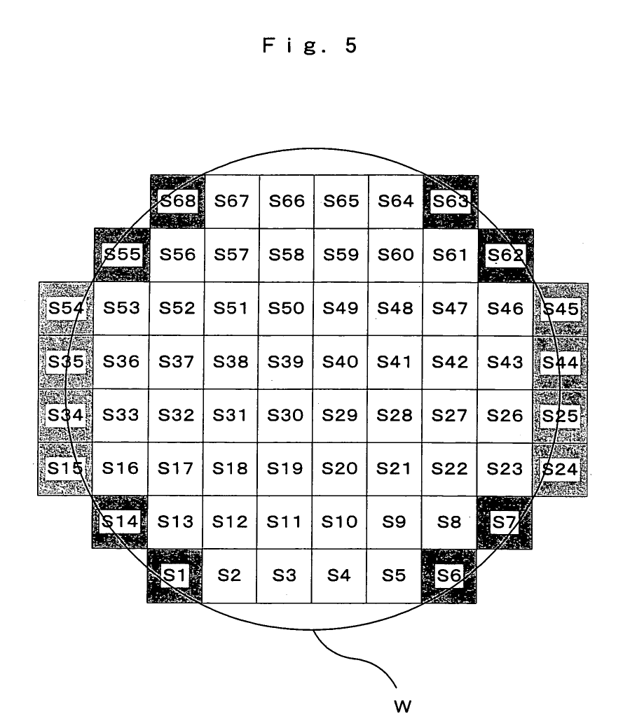

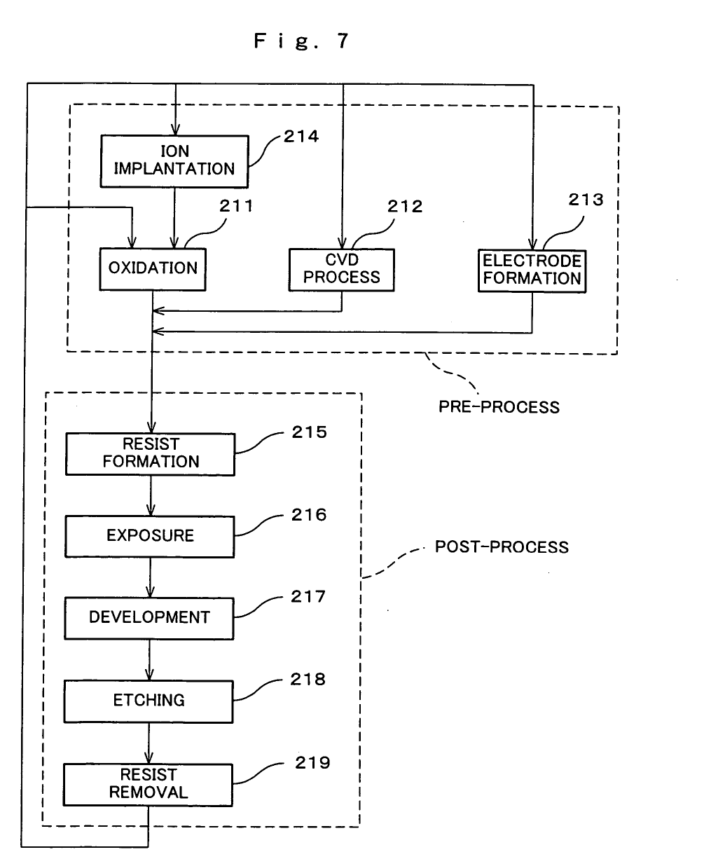

FIG. 5 shows the specific shot areas S (S2, S3, S4, S5, S64, S65, S66, and S67) as an example of the arrangement of shot areas on the wafer W on which exposure is performed by alternately changing the scanning direction on exposure of each shot area while using the exposure amount control method shown in FIGS. 4B and 4C. In FIG. 5, 16 shot areas S1, S6, S7, S14, S15, S24, S25, S34, S35, S44, S45, S54, S55, S62, S63, and S68 are so-called dummy shots. In the prior art shown in FIG. 7, 24 dummy shots were required for similar exposure whereas in this embodiment, the number of dummy shots required decreases by as many as eight. Obviously, this number of shots, eight, indicates, in consideration of the total number of shots, 68 (76 in the prior art), that the time required for exposure can be reduced by 10% or more according to a simple calculation.

Referring to FIG. 5, the eight dummy shots S1, S6, S7, S14, S55, S62, S63, and S68 located at the four corners are required to optimize the influence of fog exposure due to scattered light on the respective adjacent shots in the non-scanning direction.

As described in detail above, according to this embodiment, on exposing specific shot areas among shot areas lacking adjacent shots, on which the degree of influence of scattered light vary, the uniformity of exposure amount in the respective shot areas can be improved without forming adjacent dummy shots. Therefore, the line width uniformity can be ensured in each shot area on the wafer W with high accuracy, and the throughput can be increased.

The scanning exposure apparatus 10 of this embodiment can be made as follows. The illumination system 12 which has many mechanical and optical components; the projection optical system PL which has a plurality of lenses; the reticle stage RST which has many mechanical components; X-Y stage 14 and Z tilt stage 58 each having many mechanical components and the like, are respectively assembled, and are mechanically and optically connected to each other. This is further mechanically and electrically incorporated with the driving unit, main controller 50, and memory 51, and the like. Thereafter, overall adjustment (electrical adjustment, operation check, and the like) is performed.

The exposure apparatus 10 is preferably manufactured in a clean room in which temperature, degree of cleanliness, and the like are controlled.

A device manufacturing method using the above exposure Apparatus and method in a lithographic process will be described in detail next.

FIG. 6 is a flow chart showing an example of manufacturing a device (a semiconductor chip such as an IC or LSI, a liquid crystal panel, a CCD, a thin magnetic head, a micromachine, or the like). As shown in FIG. 6, in step 201 (design step), function/performance is designed for a device (e.g., circuit design for a semiconductor device) and a pattern to implement the function is designed. In step 202 (mask manufacturing step), a mask on which the designed circuit pattern is formed is manufactured. In step 203 (wafer manufacturing step), a wafer is manufacturing by using a silicon material or the like.

In step 204 (wafer processing step), an actual circuit and the like are formed on the wafer by lithography or the like using the mask and wafer prepared in steps 201 to 203, as will be described later. In step 205 (device assembly step), a device is assembled by using the wafer processed in step 204. Step 205 includes processes such as dicing, bonding, and packaging (chip encapsulation).

Finally, in step 206 (inspection step), a test on the operation of the device, durability test, and the like are performed. After these steps, the device is completed and shipped out.

FIG. 7 is a flow chart showing a detailed example of step 204 described above in manufacturing the semiconductor device. Referring to FIG. 7, in step 211 (oxidation step), the surface of the wafer is oxidized. In step 212 (CVD step) an insulating film is formed on the wafer surface. In step 213 (electrode formation step), an electrode is formed on the wafer by vapor deposition. In step 214 (ion implantation step), ions are implanted into the wafer. Steps 211 to 214 described above constitute a pre-process for the respective steps in the wafer process and are selectively executed in accordance with the processing required in the respective steps.

When the above pre-process is completed in the respective steps in the wafer process, a post-process is executed as follows. In this post-process, first, in step 215 (resist formation step), the wafer is coated with a photosensitive agent. Next, as in step 216, the circuit pattern on the mask is transcribed onto the wafer by the above exposure apparatus and method. Then, in step 217 (developing step), the exposed wafer is developed. In step 218 (etching step), an exposed member on a portion other than a portion where the resist is left is removed by etching. Finally, in step 219 (resist removing step), the unnecessary resist after the etching is removed.

By repeatedly performing these pre-process and post-process, multiple circuit patterns are formed on the wafer.

As described above, it becomes possible to manufacture high-integration microdevices with high productivity (high yield).

In this embodiment, line width variations due to flare in the respective shot areas in the wafer W in the scanning direction are corrected. In practice, on exposing adjacent shots in the non-scanning direction, unevenness of pattern line width can occur in the non-scanning direction due to flare although the amount is small. So for each shot area which has no adjacent shots in the non-scanning direction, an ideal light intensity distribution in the non-scanning direction can be obtained in advance, in consideration of flare, based on line width distribution data obtained in advance by measurement. And the optical members in the illumination system can be driven so as to set this ideal light intensity distribution before exposure on each shot area, thereby causing projection unevenness as disclosed in Japan Patent Laid Open No. 08-64517 and U.S. Pat. No. 5,581,075 corresponding thereto. Alternatively, a tilted unevenness correction plate may be used to positively cause tilted unevenness to correct exposure amount distributions in the non-scanning direction as disclosed in Japan Patent Laid Open No. 07-130600 and U.S. Pat. No. 5,615,047 corresponding thereto. The above disclosures are fully incorporated by reference herein. Although there is no explicit description about a scanning exposure apparatus in Japan Patent Laid Open No. 07-130600 and U.S. Pat. No. 5,615,047 corresponding thereto, the tilted unevenness correction plate disclosed in these disclosures can be suitably applied to a scanning exposure apparatus as well. By performing the above correction in the non-scanning direction, together with exposure amount correction in the scanning direction, the line width uniformity in each shot area can be further improved. Such exposure amount distribution correction in the non-scanning direction is preferably performed in accordance with an ideal light intensity distribution that is obtained for each shot. The exposure amount correction in the non-scanning direction can be performed alone.

### Second Embodiment

The second embodiment of the present invention will be described below. The scanning exposure apparatus of this embodiment has the same arrangement as that of the scanning exposure apparatus of the first embodiment, except in an exposure control program executed by the main controller 50. FIG. 1 shows the schematic arrangement of a scanning exposure apparatus 10 of this embodiment.

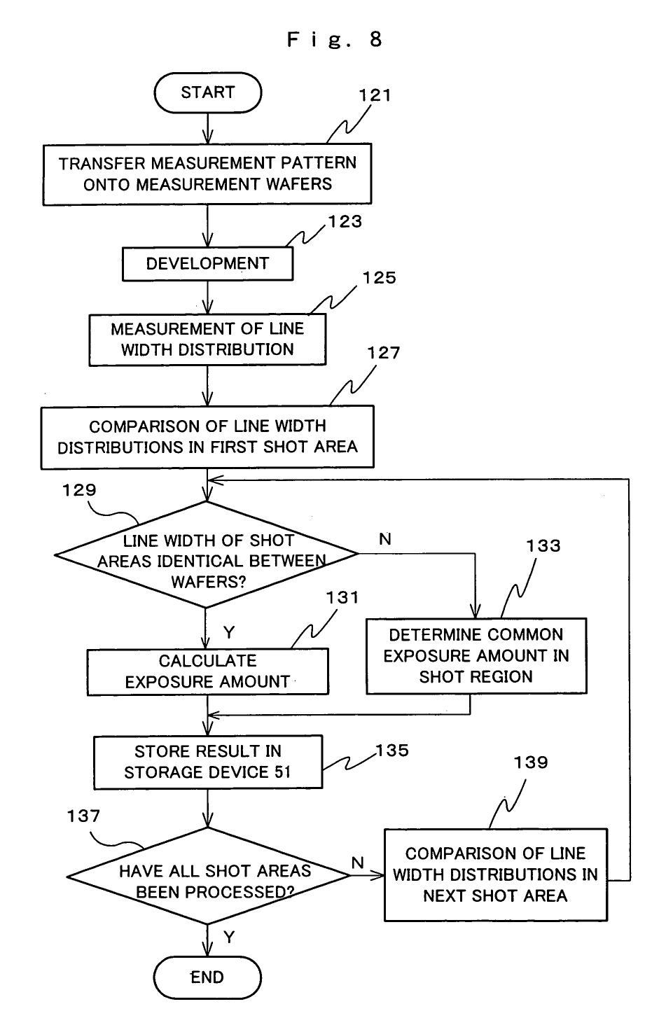

An algorithm for exposure operation, which is different from the one in the first embodiment, will be described below with reference from FIGS. 8 to 12. In this case, the scanning exposure apparatus 10 performs exposure of a reticle pattern onto a plurality of shot areas on a wafer W.

Prior to exposure for the manufacture of a device (to be referred to as “actual exposure” hereinafter), the main controller 50 determines exposure amount control data in each shot area in actual exposure under each process condition. The amount is determined based on process conditions such as the type of reticle R, the type of resist, shot area allocation on the wafer W, and the scanning direction. To decide this amount, first, in step 121 in FIG. 8, a measurement reticle for line width distribution measurement is used to transfer a line width measurement pattern formed on the measurement reticle onto the respective shot areas on M slices of measurement wafers. This is performed under the same conditions as those in actual exposure while the exposure amount is controlled to a predetermined value. In this case, the number M slices of measurement wafers on which the patterns are transferred, is a value that can be statistically sufficient in the processing to be described later. The line width measurement pattern is configured of one or more line patterns, which have a predetermined line width. The patterns can be, for example, a plurality of straight line patterns (to be referred to as H-line patterns hereinafter) extending in the X-axis direction, a plurality of straight line patterns (to be referred to as V-line patterns hereinafter) extending in the Y-axis direction. Or, it could be a combination of H-line and V-line patterns, which are respectively formed in partial areas obtained by virtually dividing the pattern region of the measurement reticle in the form of a matrix with I rows and J columns. Each partial region on the measurement reticle is transferred onto a corresponding partial region in each shot area on each measurement wafer.

In general, the line width distribution of patterns transferred onto each measurement wafer slightly varies depending on whether the wafer is scanned in the +Y direction or −Y direction on scanning exposure. Therefore, when line width control is to be performed with very high precision, patterns are transferred to M slices of measurement wafers in each of the two scanning directions.

The predetermined line width of H-line and V-line patterns is set in accordance with a line width which transfer is to be performed with high line width precision in actual exposure. That is, the line width is to be set based on a line width which line width uniformity, in particular, require improvement as a line width control target.

In general, H-line and V-line patterns transferred on measurement wafers differ in their line width distributions. When the line width uniformity of either the H-line patterns or V-line patterns is to be improved in particular, only the pattern relative need to be formed on the measurement reticle. On the other hand, when the line width uniformity of both the H-line and V-line patterns are to be improved, both patterns are to be formed on the measurement reticle. Following is a case wherein consideration is given to the line width uniformity of H-line patterns.

In step 123, the M slices of measurement wafers having completed exposure are developed. Then, in step 125, the line width of each line pattern formed on each measurement wafer is measured after development to obtain a line width distribution in each shot area from line width values in the partial areas in each shot. In this case, the line width value of each H-line pattern is obtained by statistical processing (e.g., averaging) based on the measurement line widths of H-line patterns in each partial area in each shot area.

The dependence of a line width on the exposure amount differs in dense line patterns and single line patterns. More specifically, in the case of dense line patterns, the line width greatly changes depending on the exposure amount. In the case of single line patterns, however, a change in line width with a change in exposure amount is smaller than that in the case of dense line patterns, and the line width greatly changes depending on an illumination σ value. If the patterns formed on a measurement reticle include dense line patterns and single line patterns, a line width value for each partial area in each shot area is to be obtained based on the measurement result of the line width of the dense line patterns. The line width of the linear patterns described above can be measured by using an electron microscope. In addition, if electrical wiring can be performed, line width measurement can be performed by electrical resistance measurement.

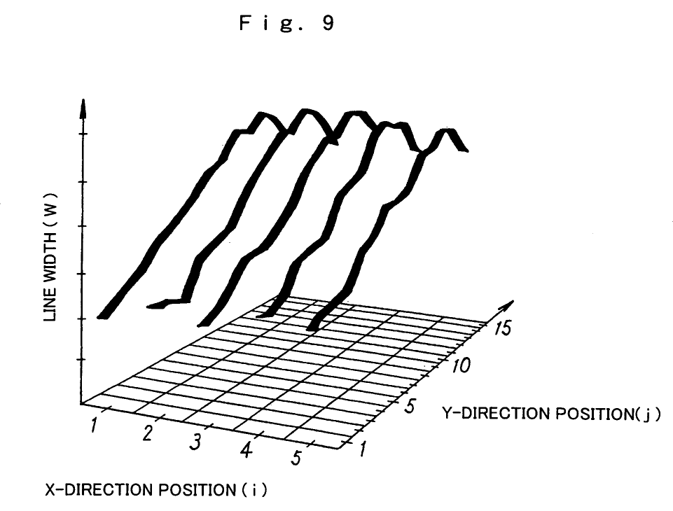

The line width distribution data in each shot area obtained in this manner becomes discrete data with respect to position, and line width data corresponding to the i^{th} (i=1 to I) measurement point in the X direction and the j^{th} (j=1 to J) measurement point in the Y direction in the n^{th} (n=1 to N, N: the number of shot areas on a measurement wafer) on the m^{th} (m=1 to M) slices of wafer is obtained in the form of W[m, n] (i, j). FIG. 9 shows an example of the line width distribution measured in this manner. In FIG. 9, I=5 and J=15.

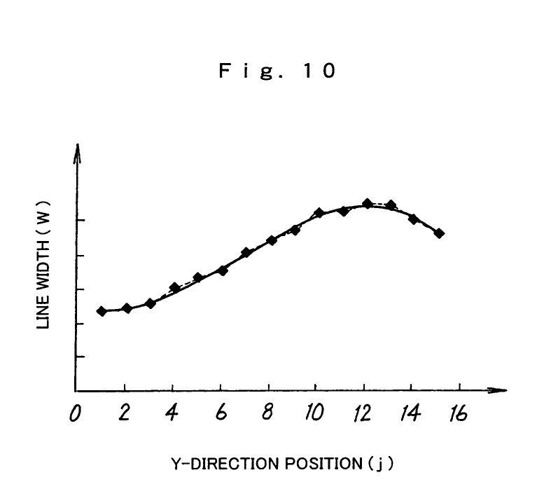

In actual exposure, line width correction in the scanning direction, i.e., the Y-axis direction, is performed, and hence a line width distribution W[m, n] (j) in the Y direction is obtained by statistically processing (e.g., averaging) each data W[m, n] (i, j) in the X direction. This W[m, n] (j) is a discrete distribution. In order to make this data correspond to each position in the shot area in the Y direction, the data is preferably converted into continuous data with respect to a position Y. For this reason, a continuous line width distribution W[m, n] (Y) in the Y direction with respect to each wafer and each shot is obtained by interpolation or curve fitting with a proper functional form. An example of this line width distribution W[m, n] (Y) is indicated by the solid line in FIG. 10. Referring to FIG. 10, the line width distribution W[m, n] (j) in the Y direction, which is obtained by averaging the line width distributions W[m, n] (i, j) in FIG. 9 in the X direction, is indicated by the dashed line, and the line width distribution W[m, n] (Y) obtained by fitting this line width distribution with a cubic curve is also shown.

When the line width distribution W[m, n] (Y) is obtained in each shot area in this manner, the line width distributions in the first shot areas on the respective measurement wafers in a synchronizing direction are compared in step 127 in FIG. 8. That is, each line width distributions W[m, 1] (Y) is compared with the other. In step 129, it is checked whether the respective line width distributions W[m, 1] (Y) are substantially equal.

If the result is affirmative in step 129, the flow advances to step 121 to obtain exposure light amounts (illumination light intensities) corresponding to positions in the shot area in the scanning direction (Y-axis direction) as follows.

In step 131, the line width distributions W[m, 1] (Y) are averaged with respect to the measurement wafers to obtain the line width distribution W[1] (Y). The line width distribution W[1] (Y) changes as the exposure amount E which is under constant value control changes. For example, in the case positive resist which has generally been used in recent years is used, as the exposure amount decreases, the line width increases, and when the exposure amount increases, the line width decreases. Accordingly, the line width distribution W[1] (Y) is expressed as a line width distribution W[1] (Y, E), when considering a change in the exposure amount E. This line width distribution W[1] (Y, E) is obtained based on the line width distribution W[l] (Y) which is obtained by the above measurement and the previously obtained relationship between line width and exposure amount. The relationship between line width and exposure amount can be estimated by calculation, or can be obtained by experiment.

Obviously, when the relationship is to be calculated, it should be noted that the calculation result does not always go along with the actual relationship. In addition, if line width uniformity is dominantly affected by reticle drawing errors, a line width distribution on the resist may have to be estimated from the line width distribution measurement result of the reticle. In this case, careful consideration must be given to the non-linearity of the relationship between the above two values.

When the relationship is obtained by experiment, scanning exposure is performed under the same condition as that of actual exposure, using a reticle for line width distribution measurement while various exposure amounts are controlled at a constant value. In this case, the exposure amount must be changed at appropriate intervals so that the range of the line width change will be equivalent with the required correction amount.

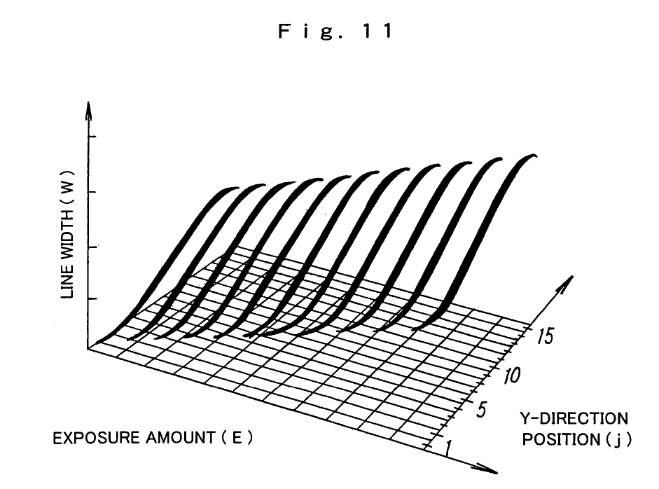

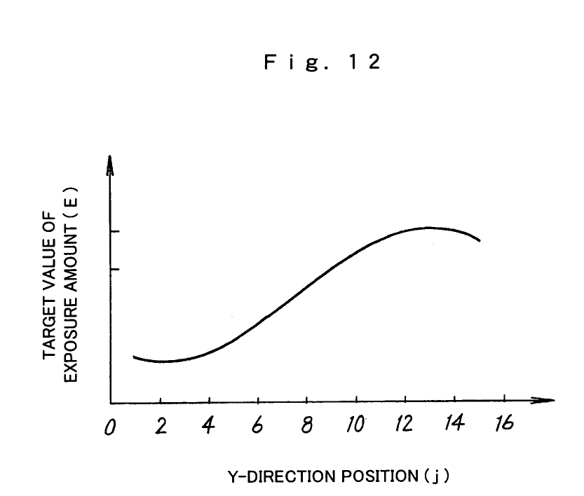

An exposure amount E[1] (Y) at each Y position is computed from the line width distribution W[l] (Y, E) (see FIG. 11) obtained in the manner described above and a predetermined target line width W₀ at each Y position (see FIG. 12). In the case positive resist is used, as mentioned earlier, and the line widths at the two ends of the first shot area in the scanning direction are small in the line width distribution W[1] (Y, E) at the time of the above line width measurement. In this case, the distribution of exposure amount in the Y direction is obtained, in which the exposure amount in an area immediately after the start of scanning exposure and an area immediately before the end of scanning exposure are smaller than those of the remaining areas. An exposure light amount P[1] (Y) at each Y position is obtained from the exposure amount E[1] (Y) obtained in this manner in consideration of a synchronous moving velocity VW of the wafer W, the width (slit width) of a slit-like exposure area 42W on the wafer W in the scanning direction, and the pulse emission period of illumination light. The exposure light amount P[1] (Y) is required to be a value between the range of the maximum exposure light amount and the minimum exposure light amount which can be adjusted by an illumination system 12. In addition, when the exposure light amount P[1] (Y) is regarded as a function P[1] (t (=(Y/V_{w}))) of time t in consideration of the synchronous moving velocity, changes in exposure light amount over time must be within the performance of the illumination system 12. If the exposure light amount P[l] (Y) obtained initially does not match the performance of the illumination system 12, the exposure light amount P[1] (Y) may be obtained again after the exposure amount E[1] (Y) is further smoothed. Alternatively, the exposure light amount P may be adjusted with at least one of the synchronous velocity V_{w} of the wafer W, slit width, and the pulse emission period of illumination light. In step 135, the exposure light amount P[1] (Y) obtained in this manner is stored in a storage device 51.

If the result is negative in step 129, the flow advances to step 133 to obtain a common exposure amount in the shot area in the scanning direction (Y-axis direction), e.g., an exposure amount E₀[1] with which an average value W[1] (E) of the line width distribution W[1] (Y, E) in the Y direction becomes a predetermined target line width W₀. A common exposure light amount P₀[1] in the shot area in the scanning direction is then determined from the common exposure amount obtained in this manner. The exposure light amount P₀[l] obtained in this manner is stored in the storage device 51 in step 135.

Next, in step 137, it is checked whether exposure light amounts P[n] (Y) or P₀[n] are obtained in all the shot areas and stored in the storage device 51. In the case above, since only the exposure light amount for exposure on the first shot area is obtained, the result is negative in step 137 and the flow then advances to step 139. In step 139, line width distributions W[2] (Y) in the synchronous direction in the second shot areas of the respective measurement wafers are compared with each other. In steps 131 to 135, as in the case of the first shot area, exposure light amounts P[2] (Y) or P₀[2] are obtained and stored in the storage device 51.

Subsequently, in step 137, the exposure light amounts P[n] (Y) or P₀[n] in the respective areas are obtained and stored in the storage device 51 until it is judged that the exposure light amounts P[n] (Y) or P₀[n] in all the shot areas are obtained and stored in the storage device 51. When the result is affirmative in step 137, then the step of determining the exposure light amount data is completed.

Instep 121 described above, in the case pattern transfer is performed in both the directions of scanning, i.e., the +Y and −Y directions, in step 123 line width data is obtained in the form of W[m, n; k] (i, j) (where k=+(+Y direction scanning) or—(−Y direction scanning)). By executing steps 125 to 139 for each k, exposure light amounts P[n ; k] (Y) or P₀[n ; k] in all the shot areas are obtained and stored in the storage device 51. If k=“+”, exposure proceeds in a direction in which j increases from 1 to J. If k=“−”, exposure proceeds in a direction which j decreases from J to 1.

According to the description above, the exposure light amount is obtained to unify the line widths of H-line patterns. However, an exposure light amount with which the line widths of V-line patterns can be unified can also be obtained in the same manner as the earlier descriptions. Furthermore, when the line widths of H-line and V-line patterns are to be unified to an appropriate degree, the line width distribution of H-line patterns and the line width distribution of V-line patterns may be separately obtained. The values obtained are then averaged upon providing desired weights, and a line width distribution in the shot area may be obtained based on the averaging result.

After determining exposure light amount data is completed in this manner, on actual exposure, the wafer W being subject to exposure, is loaded onto the Z tilt stage by a wafer loader (not shown in FIGS.). The reticle R, on which a pattern for the manufacture of a device is formed, is also loaded onto a reticle stage RST by a reticle loader (not shown in FIGS.). The main controller 50 then performs exposure light amount control based on the exposure light amount data stored in the storage device 51, transferring the pattern formed on the reticle R onto each shot area on the wafer W. On exposure, synchronous movement of the wafer W and reticle is controlled via a wafer stage driving portion 56 and reticle stage driving portion 48 based on position information (velocity information) sent from the wafer interferometer 54W and the reticle interferometer 54R to the main controller 50. In this case, the main controller 50 controls an excimer laser light source 16 and rough energy adjuster 20 to change the energy of each pulse of pulse illumination light EL in order to perform exposure light amount control, while monitoring the light intensity information (illuminance information) sent from an integrator sensor 46. Each pulse energy (light intensity) of pulse illumination light EL can be controlled by adjusting at least one of the voltage applied from a high-voltage power supply 16e of an excimer laser light source 16 to a laser resonator 16d and the ND filter of the rough energy adjuster 20.

The object of exposure light amount control is to adjust the exposure amount to unify the line width distributions of patterns on the wafer W. To perform this exposure amount adjustment, the main controller 50 can control the variable blind 30 to control the width of an illumination area 42R on the reticle R in the scanning direction and the width of an exposure area 42W on the wafer W in the scanning direction while keeping the light intensity (illuminance) of pulse illumination light EL constant. In addition, the main controller 50 may change the synchronous moving velocity of the wafer W and reticle R by controlling the wafer stage driving portion 56W and reticle stage driving portion 56R. Furthermore, the pulse emission frequency of the pulse illumination light EL may be changed.

The main controller 50 may control at least one of the energy of each pulse of the pulse illumination light EL, the pulse intervals, the width of illumination area 42R and exposure area 42W in the scanning direction, and the synchronous moving velocity of the wafer W and reticle R such that an exposure amount based on the exposure amount E[n] (Y) or E₀[n] is irradiated on the wafer W before the light passes through the exposure area 42W on the wafer W.

As described above, according to this embodiment, on transferring patterns onto the wafer W, the exposure amount at each position in each shot area in the scanning direction is controlled to cancel out the transfer error of a pattern line width which is caused in the scanning direction when a constant exposure amount is set as a target value in the whole shot areas. This makes it possible to perform high-precision pattern transfer.

The scanning exposure apparatus 10 of this embodiment can be made as follows. As in the first embodiment, an illumination system 12 having many mechanical and optical components and the like and a projection optical system PL having a plurality of lenses and the like, together with the reticle stage RST, an X-Y stage 14, and a Z tilt stage 58 each having many mechanical components and the like, are assembled together and mechanically and optically connected to each other. This is further mechanically and electrically incorporated with the driving units, main controller 50, and memory 51, and the like. Then, overall adjustment (electrical adjustment, operation check, and the like) is performed.

By applying the exposure apparatus and method of this embodiment to the device manufacturing method described with reference to FIGS. 6 and 7, a device on which fine patterns are formed with high precision can be manufactured.

In this embodiment, exposure for measurement is performed to obtain the transfer error of a pattern line width that is caused by a combination of all factors for this error. For example, a drawing error in each pattern formed on the reticle R, the unevenness of the resist thickness on the wafer W, a focus control error between the image plane of the projection optical system PL and the exposure area 42W on the wafer W, a synchronous movement control error between the reticle R and the wafer W, and scattered light produced in the projection optical system PL. The exposure amount of the wafer W is controlled based on the measurement result. In contrast to this, if the characteristics of the respective factors for the transfer error of a pattern line width are already known, the transfer error of a pattern line width can be calculated based on the characteristics of the respective factors, and the exposure amount for the wafer W can be controlled based on the calculation result.

In this embodiment, the exposure light amount data P is individually controlled for each shot area. If, however, there is commonality in the transfer error of a pattern line width between shot areas, exposure light amount data can be controlled in units of shot area groups, which have a commonality. In this case, the amount of data controlled can be reduced. For example, when the transfer error of a pattern line width is mainly, a drawing error in a pattern formed on the reticle R which does not originate from the scanning exposure apparatus itself and does not vary depending on scanning exposure apparatus used and positions in shot areas, in this case, all the shot areas have commonality in the transfer error of a pattern line. Since all the shot areas have a commonality, control of only one exposure light is necessary. Also, in the case the transfer error of a pattern line width is mainly caused by the unevenness of the resist thickness on the wafer W in the radial direction of the wafer W and flare, and corresponds to the positional relationship between a shot area on the wafer W and neighboring shot areas, the shot areas can be formed into several groups each having commonality in the transfer error of a pattern line width. In such a case, exposure light amount data can be controlled according to the number of groups. The exposure amount data E also can be controlled in the same manner.

With the first and second embodiments, the scanning exposure apparatus and their scanning exposure methods have been described, each using an excimer laser light source as a light source, which is a kind of pulse laser light source. The present invention is, however, not limited to this. It can be applied, for example, to a scanning exposure apparatus which uses an ultra-high pressure mercury lamp as a light source and continuous light such as an emission line (g line or i line) in the ultraviolet range which is emitted by the light source as the exposure illumination light, and its scanning exposure method. In this exposure apparatus using such a lamp as a light source, the above exposure amount control during synchronous movement can be easily implemented by adjusting at least one of the above synchronous moving velocity and slit width. Alternatively, the exposure amount may be adjusted by controlling the output (lamp power) of the lamp light source or controlling a transmittance control element arranged in an illumination optical system, e.g., a variable transmittance element using two diffraction grating plates whose relative positions can be adjusted.

In addition, the present invention is applicable to any wafer exposure apparatus and liquid crystal exposure apparatus such as a reduction projection exposure apparatus using ultraviolet light as a light source, a reduction projection exposure apparatus using soft X-rays having a wavelength of about 10 nm as a light source, an X-ray exposure apparatus using light having a wavelength of about 1 nm as a light source, and an exposure apparatus using an EB (Electron Beam) or ion beam.

As has been described above, the exposure apparatus and method according to the present invention are suited to form a fine pattern onto a substrate such as a wafer with high precision in a lithography process for manufacturing a microdevice such as an integrated circuit.

In addition, the device manufacturing method according to the present invention is suited to manufacture a device having a fine pattern, and the device according to the present invention is suited to make an apparatus or the like which is required to have high integration and high pattern precision.

While the above-described embodiments of the present invention are the presently preferred embodiments thereof, those skilled in the art of lithography systems will readily recognize that numerous additions, modifications and substitutions may be made to the above-described embodiments without departing from the spirit and scope thereof. It is intended that all such modifications, additions and substitutions fall within the scope of the present invention, which is best defined by the claims appended below.

1: A scanning exposure method of sequentially transferring a pattern formed on a mask onto a plurality of shot areas on a substrate through a projection optical system, in which said mask and said substrate are moved synchronously while illuminating said mask with an exposure light, said method comprising:
transferring said pattern onto a specific shot area which is located at an edge of said substrate; and
performing exposure amount adjustment, in a manner that an exposure amount at an edge portion of said specific shot area is different from that of a remaining portion in said specific shot area, when said specific shot area is to be exposed, said edge portion being located on a side where there is no adjacent shot area.

2: A scanning exposure method according to claim 1, wherein said exposure amount adjustment is performed so that an exposure amount at said edge portion of said shot specific area is larger than that of said remaining portion.

3: A scanning exposure according to claim 1, wherein said exposure amount adjustment is performed by gradually increasing an exposure amount at said edge portion of said specific shot area step by step as a distance becomes far from a center of said specific shot area.

4: A scanning exposure method according to claim 1, wherein said exposure amount adjustment is performed by gradually increasing an exposure amount at said edge portion of said specific shot area continuously as a distance becomes far from a center of said specific shot area.

5: A scanning exposure method according to claim 1, wherein said exposure amount adjustment is performed by changing an exposure amount at said edge portion of said specific shot area in accordance with a predetermined function corresponding to at least one of a transmittance of said mask and an illumination condition.

6: A scanning exposure method according to claim 5, wherein said predetermined function is obtained in advance by experiment.

7: A scanning exposure method according to claim 1, wherein said edge portion of said specific shot area is at least one of
an edge portion in a first direction which is a moving direction in which said substrate is moved for exposure of said specific shot area, and
an edge portion in a second direction perpendicular to said first direction.

8: A scanning exposure method according to claim 7, wherein
said edge portion of said specific shot area is an edge portion in said first direction, and
said exposure amount adjustment is performed during scanning exposure of said specific shot area.

9: A scanning exposure method according to claim 8, wherein said exposure light is a pulse light emitted from a pulse illumination light source, and said exposure amount adjustment is performed by adjusting at least one of an oscillation frequency of said pulse illumination light source and energy of pulse illumination light.

10: A scanning exposure method according to claim 8, wherein said exposure light is a lamp light emitted from a lamp light source, and said exposure amount adjustment is performed by adjusting at least one of a lamp power and a transmittance control element arranged on an optical path of said exposure light.

11: A scanning exposure method according to claim 8, wherein said exposure amount adjustment is performed by changing at least one of a moving velocity of said substrate and a width of an exposure area on said substrate in said first direction.

12: A scanning exposure method according to claim 7, wherein said edge portion of said specific shot area is an edge portion in said second direction.

13: A scanning exposure method according to claim 12, wherein said exposure amount adjustment is performed by adjusting an light intensity distribution of exposure light irradiated onto said substrate in a direction corresponding to said second direction.

14: A scanning exposure method of sequentially transferring a pattern formed on a mask onto a plurality of 10 shot areas on a substrate through a projection optical system, in which said mask and said substrate are moved synchronously while illuminating said mask with an exposure light, said method comprising:
judging whether there is an adjacent shot area in a predetermined direction before transferring said pattern onto each shot area on said substrate;
calculating a second function for exposure amount correction performed for a specific shot area where there is no adjacent shot area in said predetermined direction, by using a first function corresponding to at least one of a transmittance of said mask and an illumination condition; and
transferring said pattern onto said specific shot area while controlling an exposure amount based on a calculation result obtained in said calculating.

15: A scanning exposure method according to claim 14, wherein said predetermined direction is at least one of
a first direction which is a moving direction in which said substrate is moved for exposure said specific shot area, and
a second direction perpendicular to said first direction.

16: A scanning exposure method of transferring a pattern of a mask onto a plurality of shot areas on a substrate by synchronously moving said mask and said substrate during an exposure of each of said shot areas, comprising,
partially changing a target exposure amount with respect to said substrate while exposing a specific shot area of said plurality of shot areas where there is no adjacent shot area in a predetermined direction.

17: A scanning exposure method according to claim 16, wherein said exposure amount is partially changed with respect to said substrate in consideration of an influence of scattered light caused when said substrate is exposed.

18: A scanning exposure method according to claim 16, wherein said predetermined direction is at least one of
a first direction which is a moving direction in which said substrate is moved for exposure said specific shot area, and
a second direction perpendicular to said first direction.

19-52 (Canceled).
